(19) United States
(12) Patent Application Publication
(10) Pub. No.: US 2009/0253416 A1
(43) Pub. Date: Oct. 8, 2009

(54) METHOD AND SYSTEM FOR PROVIDING USER DEFINED BUNDLE IN A MOBILE BROADCAST SYSTEM

(75) Inventors: Jong-Hyo LEE, Pyeongtaek-si (KR); Kook-Heui LEE, Suwon-si (KR); Sung-Oh HWANG, Yongin-si (KR); Bo-Sun JUNG, Seongnam-si (KR); Jun-Hyung KIM, Suwon-si (KR); Ji-Eun KEUM, Suwon-si (KR)

Correspondence Address: Jefferson IP Law, LLP, 1130 Connecticut Ave., NW, Suite 420, Washington, DC, 20036, US

(73) Assignee: Samsung Electronics Co. Ltd., Suwon-si (KR)

(21) Appl. No.: 12/418,184

(22) Filed: Apr. 3, 2009

(30) Foreign Application Priority Data
Apr. 4, 2008 (KR) 10-2008-0031897
Dec. 2, 2008 (KR) 10-2008-0121222
Feb. 5, 2009 (KR) 10-2009-0009500

(51) Int. Cl. H04M 3/42

(52) U.S. Cl. 455/414.1

(57) ABSTRACT

A method and mobile communication system for providing a user defined bundle in a terminal of a mobile broadcast system are provided. The method includes receiving a service guide from a BroadCAST (BCAST) Service Distribution/Adaptation (BSDA), creating a user defined bundle based on a content or a service desired by a user, including the user defined bundle in a user defined bundle subscription request message and transmitting the user defined bundle subscription request message to a BCAST Subscription Management (BSM), and receiving from the BSM a user defined bundle subscription response message in which a user defined bundle subscription and a purchase complete message is included.

### PRIORITY

This application claims the benefit under 35 U.S.C. § 119(a) of a Korean patent application filed in the Korean Intellectual Property Office on Apr. 4, 2008 and assigned Serial No. 10-2008-0031897, a Korean patent application filed in the Korean Intellectual Property Office on Dec. 2, 2008 and assigned Serial No. 10-2008-0121222, and a Korean patent application filed in the Korean Intellectual Property Office on Feb. 5, 2009 and assigned Serial No. 10-2009-0009500, the entire disclosures of all of which are hereby incorporated by reference.

### BACKGROUND OF THE INVENTION

1. Field of the Invention

The present invention relates to a mobile broadcast system. More particularly, the present invention relates to a method and system for providing broadcast services in a mobile broadcast system.

2. Description of the Related Art

Mobile communication markets produce new services through recombination or integration of existing technologies. Presently, the development of communication and broadcast technologies has enabled conventional broadcast systems or mobile communication systems to offer broadcast services over portable terminals (or mobile terminals), such as mobile phones, Personal Digital Assistants (PDA) and the like. A convergence of mobile communication services and Internet Protocol (IP) results in developing next-generation mobile communication technologies in connection with latent and practical market needs, increasing user demands for multimedia services, policies of service providers offering new services such as broadcast services in addition to existing voice services and interests of Information Technology (IT) enterprises reinforcing their mobile communication businesses and accepting users demands. In this regard, not only the mobile communication markets, but also wired communication markets introduce and offer diverse services using wire/wireless broadcasts. Accordingly, the convergence has made a variety of services, especially desirable, regardless of whether they use wired/wireless broadcasts.

Meanwhile, Open Mobile Alliance (OMA), an institution founded to research standards for interworking between individual mobile solutions, establishes up a variety of application standards for games over mobile communication, Internet services and the like. More particularly, OMA Mobile BroadCAST (BCAST) Working Group among OMA Working Groups establishes and maintains standards offering broadcast services over mobile terminals. The OMA BCAST standardizes technologies for providing IP-based broadcast services in the portable terminal environment, such as service guide, download and streaming transmission technologies, a service/content protection technology, service subscription and roaming.

Consistent with the trend of the integrated service provision markets formed by the convergence of wire/wireless environments, mobile broadcast technologies, such as the OMA BCAST, may also evolve to help offer services in the wire/wireless integrated environment beyond the mobile environment.

Therefore, a need exists for a system and method for creating a bundle of services in a mobile broadcast system.

### SUMMARY OF THE INVENTION

An aspect of the present invention is to address at least the above-mentioned problems and/or disadvantages and to provide at least the advantages described below. Accordingly, an aspect of the present invention is to provide a method and system for creating a bundle of services selected by a user, while taking the user preference into account, and providing the user defined bundle in a mobile broadcast system.

In accordance with one aspect of the present invention, a method for providing a user defined bundle in a terminal of a mobile broadcast system is provided. The method includes receiving a service guide from a BroadCAST (BCAST) Service Distribution/Adaptation (BSDA), creating a user defined bundle based on a content or a service, including the user defined bundle in a user defined bundle subscription request message and transmitting the user defined bundle subscription request message to a BCAST Subscription Management (BSM), and receiving from the BSM a user defined bundle subscription response message in which a user defined bundle subscription and a purchase complete message is included.

In accordance with another aspect of the present invention, a method for providing a user defined bundle in a BCAST Subscription Management (BSM) of a mobile broadcast system is provided. The method includes receiving a user defined bundle subscription request message from a terminal, determining whether to provide a user defined bundle service, receiving a purchase inquiry response message from the terminal, and checking whether a user accepts purchase by analyzing the purchase inquiry response message, including a user defined bundle subscription and purchase complete message in a user defined bundle subscription response message, and transmitting the user defined bundle subscription response message to the terminal when the user accepts the purchase.

In accordance with still another aspect of the present invention, a mobile communication system providing a user defined bundle is provided. The system includes a terminal for receiving a service guide from a BCAST Service Distribution/Adaptation (BSDA), for creating a user defined bundle based on a content or a service desired by a user, for including the user defined bundle in a user defined bundle subscription request message, for transmitting the user defined bundle subscription request message to a BCAST Subscription Management (BSM), for receiving a purchase inquiry request message from the BSM, for creating a purchase inquiry response message upon receipt of a purchase accept from the user, for transmitting the purchase inquiry response message to the BSM, and for receiving a user defined bundle subscription response message with a user defined bundle subscription and purchase complete message from the BSM, and the BSM for receiving the user defined bundle subscription request message from the terminal, for determining whether to provide a user defined bundle service by analyzing the user defined bundle subscription request message, for including the user defined bundle service in the purchase inquiry request message when the BSM determines to provide the user defined bundle, for transmitting the purchase inquiry request message to the terminal, for receiving the purchase inquiry response message from the terminal, for determining whether the user accepts the purchase by analyzing the purchase inquiry response message, for including the user defined bundle subscription and purchase complete message in the user defined bundle subscription response message when it is determined that the user accepts the purchase, and for transmitting the user defined bundle subscription response message to the terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a logical architecture of an Open Mobile Alliance (OMA) BroadCAST (BCAST) according to an exemplary embodiment of the present invention;

FIG. 2 illustrates a service guide data model for service guide creation in an OMA BCAST according to an exemplary embodiment of the present invention;

FIG. 3 is a message flow diagram according to an exemplary embodiment of the present invention;

FIG. 4 illustrates an operation of a terminal according to an exemplary embodiment of the present invention; and

FIG. 5 illustrates an operation of a BCAST Subscription Management (BSM) according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a”, “an” and “the” include plural referents unless the context clearly dictates otherwise. Thus, for example, reference to “a component surface” includes reference to one or more of such surfaces.

The names of entities defined in a 3rd Generation Partnership Project (3GPP) which is a standard for asynchronous mobile communication, or in an Open Mobile Alliance (OMA) BroadCAST (BCAST) which is a standard institution for applications of mobile terminals, will be used for convenience of explanation only. Any standards and/or the entity names described herein are not intended to limit the scope of the present invention. Further, exemplary embodiments of the present invention may also be applied to any other systems having similar technical backgrounds. Before a description of the exemplary embodiments of the present invention are given, a message scheme table used in exemplary embodiments of the present invention will be described with reference to Table 1A to assist in a comprehensive understanding of exemplary embodiments of the present invention.

In Table 1A, “Name” denotes names of elements and attributes constituting an arbitrary message. “Type” denotes whether a type of arbitrary name is an element or an attribute. The elements have values of E1, E2, E3 and E4, in which E1 indicates an upper element for the entire message, E2 a sub-element of E1, E3 a sub-element of E2, and E4 a sub-element of E3. The attributes are denoted by A, and A indicates an attribute of an arbitrary element. For example, ‘A’ under E1 denotes an attribute of E1. “Category” is used to determine whether an arbitrary element or attribute is mandatory or optional, and has a value M for a mandatory element or attribute, and a value 0 for an optional element or attribute. “Cardinality” denotes a relationship between elements, and has values of 0, 0 . . . 1, 1, 0 . . . n, 1 . . . n. Here, “0” denotes an optional relationship, “1” denotes a mandatory relationship, and “n” denotes a possibility of having a plurality of values. For example, “0 . . . n” denotes that an arbitrary element may be optional or may have n values. “Description” denotes a meaning of an arbitrary element or attribute, and “Data Type” denotes a data type for an arbitrary element or attribute.

TABLE 1A

| | | | | | |
|---|---|---|---|---|---|
| Name | Type | Category | Cardinality | Description | Data Type |

In addition, because an exemplary embodiment of the present invention is based on a standard defined by the BCAST, when a procedure and/or message elements defined by BCAST are used, a detailed description thereof will be omitted for conciseness.

Although a description of exemplary embodiments of the present invention will be given below based on OMA BCAST technology, which is one of the mobile broadcast standards, used herein as an example, the description thereof is not intended to limit the scope of the present invention.

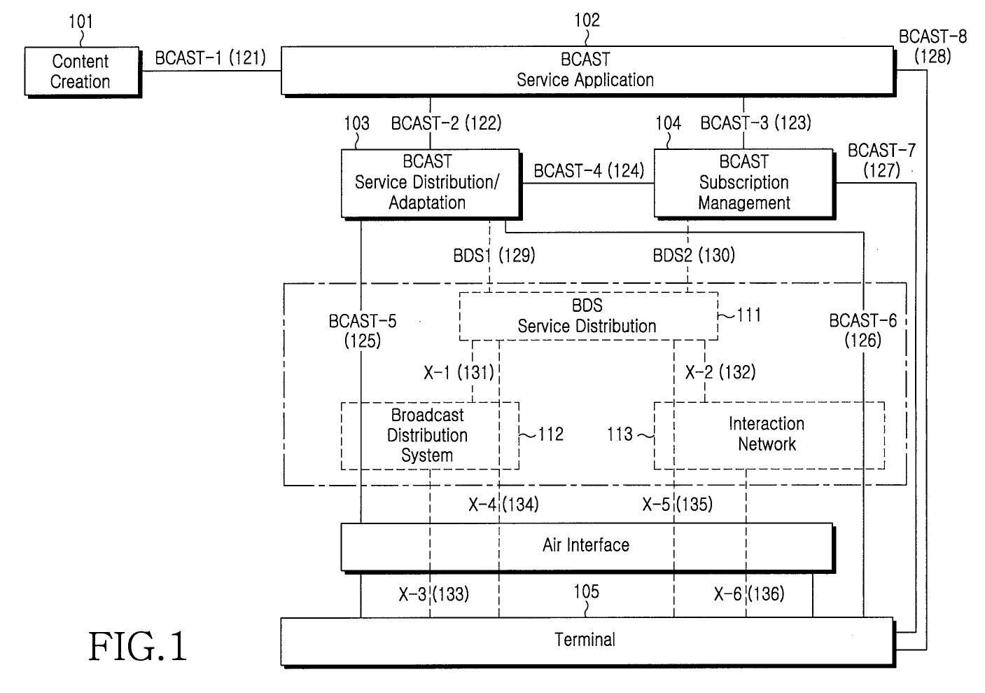

FIG. 1 illustrates a logical architecture for an OMA BCAST according to an exemplary embodiment of the present invention. In FIG. 1, logical entities will be described in detail.

Referring to FIG. 1, a Content Creation (CC) 101 provides contents that become a basis of the BCAST services. The contents may include common files for broadcast services, for example, data for movies, audios and videos. Further, the Content Creation 101 creates service guides, and provides a BCAST Service Application 102 with attributes for the contents, used to determine transport bearers over which the service guides are to be delivered.

The BCAST Service Application 102 converts data for BCAST services, provided from the Content Creation 101, into a format suitable to provide media encoding, content protection and interactive services. Further, the BCAST Service Application 102 provides the attributes for the contents, received from the Content Creation 101, to a BCAST Service Distribution/Adaptation (BSDA) 103 and a BCAST Subscription Management (BSM) 104.

The BCAST Service Distribution/Adaptation 103 performs operations file/streaming transmission, service gathering, service protection, service guide creation/delivery and service notification, using the BCAST service data provided from the BCAST Service Application 102. Further, the BCAST Service Distribution/Adaptation 103 adapts the services to a broadcast distribution system (BDS) 112.

The BCAST Subscription Management 104 manages service provisioning, such as subscription and price-relation functions in a hardware or software manner for BCAST service users, provisioning for information used for BCAST services, and terminals receiving BCAST services.

A terminal 105 receives contents and program support information, such as service guide and content protection, and provides broadcast services to users based on the received information. A BDS Service Distribution 111 delivers mobile broadcast services to a plurality of terminals through mutual communication with the broadcast distribution system 112 and an interaction network 113.

The broadcast distribution system 112 delivers mobile broadcast services through broadcast channels, and may include, for example, a Multimedia Broadcast Multicast Service (MBMS) of 3GPP, a Broadcast Multicast Service (BCMCS) of 3rd Generation Project Partnership 2 (3GPP2) which is a standard institution for 3rd generation synchronous mobile communication, a Digital Video Broadcasting -Handheld (DVB-H) which is a standard institution for digital broadcasting, or an Internet Protocol (IP)-based broadcast/communication network. The interaction network 113 provides interaction channels, and may include, for example, a cellular network and the like.

A description will now be made of reference points which are connection paths between the logical entities. The reference points have a plurality of interfaces according to their purposes. The interfaces are used for communication between two or more logical entities, for specific purposes. Message formats and protocols for the interfaces are applicable.

BCAST-1 121 is a transmission path for contents and content attributes, and BCAST-2 122 is a transmission path for content-protected or content-unprotected BCAST services, attributes of the BCAST services, and content attributes.

BCAST-3 123 is a transmission path for attributes of BCAST services, content attributes, user preference/subscription information, user requests, and responses to the requests.

BCAST-4 124 is a transmission path for notification messages, attributes used for service guides and keys used for content protection and service protection.

BCAST-5 125 is a transmission path for protected BCAST services, unprotected BCAST services, content-protected BCAST services, content-unprotected BCAST services, BCAST service attributes, content attributes, notification, service guides, security materials including Digital Right Management (DRM) Right Objects (RO) and key values used for BCAST service protection, and all data and signals which are transmitted through broadcast channels.

BCAST-6 126 is a transmission path for protected BCAST services, unprotected BCAST services, content-protected BCAST services, content-unprotected BCAST services, BCAST service attributes, content attributes, notifications, service guides, security materials including Digital Right Management (DRM) Right Objects (RO) and key values used for BCAST service protection, and all data and signals which are transmitted through interaction channels.

BCAST-7 127 is a transmission path for service provisioning, subscription information, device management, and user preference information transmitted through interaction channels of reception-related control information, such as security materials including DRM RO and key values used for BCAST service protection.

BCAST-8 128 is a transmission path where user data for BCAST services interacts. BDS-1 129 is a transmission path for protected BCAST services, unprotected BCAST services, BCAST service attributes, content attributes, notifications, service guides, and security materials including DRM RO and key values used for BCAST service protection.

BDS-2 130 is a transmission path for service provisioning, subscription information, device management, and security materials including DRM RO and key values used for BCAST service protection.

X-1 131 is a reference point between the BDS Service Distribution 111 and the broadcast distribution system 112. X-2 132 is a reference point between the BDS Service Distribution 111 and the interaction network 113. X-3 133 is a reference point between the broadcast distribution system 112 and the terminal 105. X-4 134 is a reference point between the BDS Service Distribution 111 and the terminal 105 through a broadcast channel. X-5 135 is a reference point between the BDS Service Distribution 111 and the terminal 105 through an interaction channel. X-6 136 is a reference point between the interaction network 113 and the terminal 105.

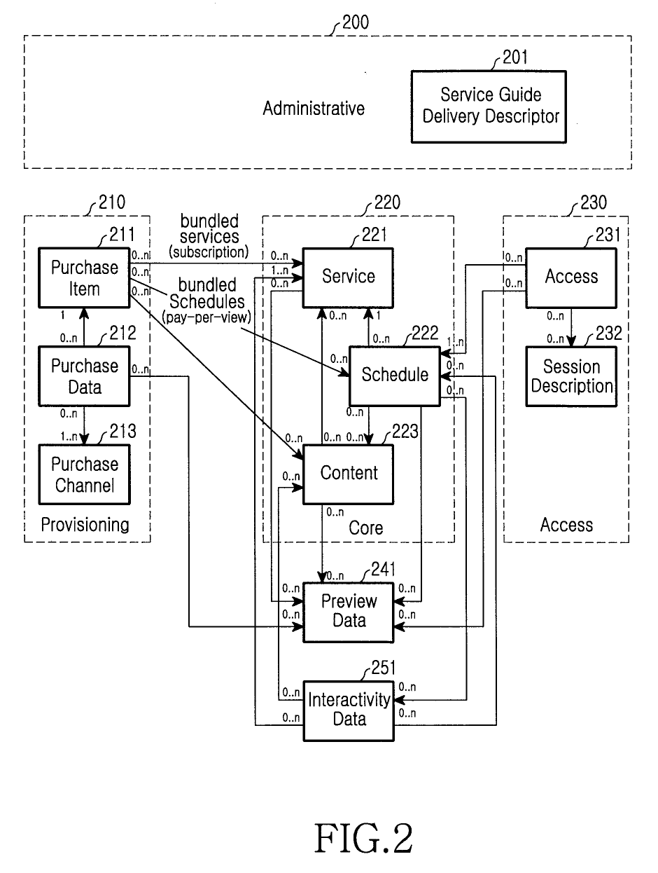

FIG. 2 illustrates a service guide data model for service guide creation in an OMA BCAST according to an exemplary embodiment of the present invention. In FIG. 2, solid lines connecting respective fragments denote mutual references between the fragments.

Referring to FIG. 2, a service guide data model includes an Administrative group 200 that provides upper configuration information of an entire service guide, a Core group 220 which is a core part of the service guide, including service, content and schedule, an Access group 230 that provides access information to enable access to service or contents, and a Provisioning group 210 that includes subscription and purchase information. With regards to components of each group, the Administrative group 200 includes ServiceGuideDeliveryDescriptor 201, and the Provisioning group 201 includes PurchaseItem 211, PurchaseData 212, and PurchaseChannel 213. Further, the Core group 220 includes Service 221, Schedule 222, and Content 223. The Access group 230 includes Access 231 and SessionDescription 232.

Other service guide information, as illustrated in FIG. 2, includes PreviewData 241 and InteractivityData 251 in addition to the above-described four (4) groups of the service guide. The components of each group described above are referred to as fragments, which are units forming the service guide.

More specifically, the ServiceGuideDeliveryDescriptor fragment 201 indicates information on a delivery session in which a ServiceGuideDeliveryUnit (SGDU) containing fragments constituting the service guide is located, and indicates an entry point used for receiving grouping information for the SGDU and a notification message.

The Service fragment 221, an upper set of contents included in broadcast services in the entire service guide, includes information on service details, genres, service areas and the like.

The Schedule fragment 222 indicates time information for respective contents included in such services as streaming and downloading.

The Content fragment 223 includes description, target user group, service area, genre and the like of the contents being broadcasted.

The Access fragment 231 provides information related to an access to enable service viewing. The Access fragment 231 also provides a delivery method and session information for the corresponding access session.

The SessionDescription fragment 232 may be included in the Access fragment 231, and provides location information in the form of Uniform Resource Identifier (URI) so that the terminal may verify information of the SessionDescription fragment 232. The SessionDescription fragment 232 provides address information, codec information and the like for multimedia contents existing in the corresponding session.

The PurchaseItem fragment 211 provides a bundle of services, contents, times and the like to help users subscribe to or purchase the PurchaseItem fragment 211.

The PurchaseData fragment 212 includes detailed information regarding purchase and subscription, including price information and promotion information for the services or service bundle.

The PurchaseChannel fragment 213 indicates access information for subscription or purchase. The ServiceGuideDeliveryDescriptor fragment 201 indicates an entry point for service guide reception and grouping information for the SGDU which is a container of the fragment.

In addition, preview information for service, schedule and contents may be provided through the PreviewData fragment 241. Interactive services may also be provided through the InteractivityData fragment 251 during broadcasting according to the service, schedule and contents. Detailed information regarding the service guide may be defined with various elements and attributes used for providing details and values, based on an upper data model of FIG. 2.

Although detailed elements and attributes for the fragments of the service guide are not provided herein for convenience of explanation only, the detailed elements and attributes described herein do not limit the scope of the present invention. In an exemplary implementation, all elements and attributes defined for providing a service guide for mobile broadcast services may be applied.

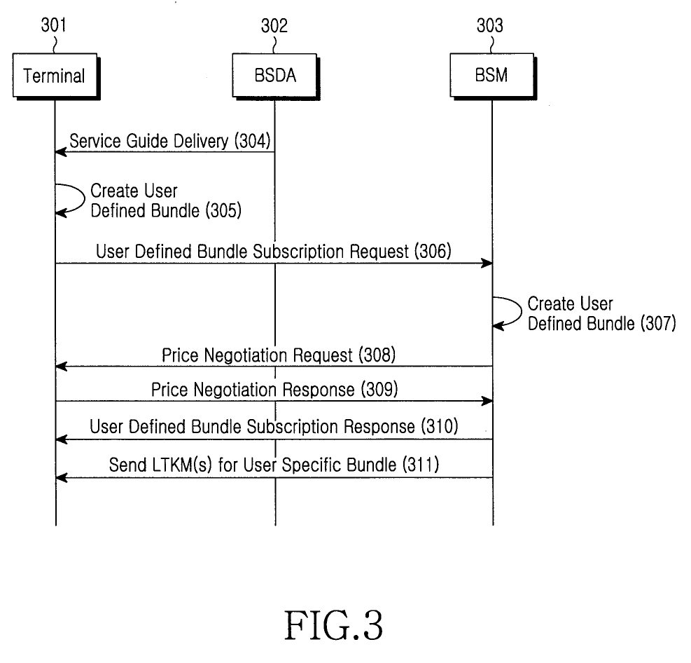

FIG. 3 is a message flow diagram according to an exemplary embodiment of the present invention.

Logical objects in FIG. 3, including a terminal 301, a BCAST Service Distribution/Adaptation (BSDA) 302 and a BCAST Subscription Management (BSM) 303, are similar to the objects 105, 103 and 104 in FIG. 1, respectively.

Referring to FIG. 3, the terminal 301 receives a service guide from the BSDA 302 and illustrates details of the received service guide to a user in step 304. Here, information regarding all services and contents that a BCAST service provider provides is provided to the terminal 301 through the service guide delivered in step 304. Further, in step 304, the BSM 303 may inform that the user may create in person a bundle for the services and contents written in the service guide when desired. As a result, a UDBAllowed element is added to the Service and Content fragments in the service guide and provided to the user. A format thereof is illustrated in Table. 1B and 1C.

TABLE 1B

| Name | Type | Category | Cardinality | Description | Data Type |
|---|---|---|---|---|---|
| Service | E | | | ‘Service’ fragment | |
| | | | | Contains the following | |
| | | | | attributes: | |
| | | | | id | |
| | | | | version | |
| | | | | validFrom | |
| | | | | validTo | |
| | | | | globalServiceID | |
| | | | | weight | |
| | | | | baseCID | |
| | | | | emergency | |
| | | | | Contains the following | |
| | | | | elements: | |
| | | | | ProtectionKeyID | |
| | | | | ServiceType | |
| | | | | Name | |
| | | | | Description | |
| | | | | AudioLanguage | |
| | | | | TextLanguage | |
| | | | | ParentalRating | |
| | | | | TargetUserProfile | |
| | | | | Genre | |
| | | | | Extension | |
| | | | | UDBAllowed | |
| | | | | PreviewDataReference | |
| | | | | BroadcastArea | |
| | | | | TermsOfUse | |
| | | | | PrivateExt | |
| id | A | NM/ | 1 | ID of the ‘Service’ | anyURI |
| | | TM | | fragment. The value of | |
| | | | | this attribute SHALL | |
| | | | | be globally unique.” | |
| version | A | NM/ | 1 | Version of this | unsignedInt |
| | | TM | | fragment. The newer | |
| | | | | version overrides the | |
| | | | | older one starting from | |
| | | | | the time specified by | |
| | | | | the ‘validFrom’ | |
| | | | | attribute, or as soon as | |
| | | | | it has been received if | |
| | | | | no ‘validFrom’ | |
| | | | | attribute is given. | |
| validFrom | A | NM/ | 0 . . . 1 | The first moment when | unsignedInt |
| | | TM | | this fragment is valid. If | |
| | | | | not given, the validity | |
| | | | | is assumed to have | |
| | | | | started at some time in | |
| | | | | the past. This field | |
| | | | | contains the 32bits | |
| | | | | integer part of an NTP | |
| | | | | time stamp. | |
| validTo | A | NM/ | 0 . . . 1 | The last moment when | unsignedInt |
| | | TM | | this fragment is valid. If | |
| | | | | not given, the validity | |
| | | | | is assumed to end in an | |
| | | | | undefined time in the | |
| | | | | future. | |
| globalServiceID | A | NM/ | 0 . . . 1 | The globally unique | anyURI |
| | | TM | | identifier identifying | |
| | | | | the service this | |
| | | | | ‘Service’ fragment | |
| | | | | describes. | |
| weight | A | NM/ | 0 . . . 1 | Intended order of | unsignedShort |
| | | TM | | display of this service | |
| | | | | relative to other | |
| | | | | services as presented to | |
| | | | | the end user. The order | |
| | | | | of display is by | |
| | | | | increasing weight value | |
| | | | | (i.e., service with | |
| | | | | lowest weight is | |
| | | | | displayed first). | |
| | | | | Default: 65535 | |
| | | | | User preference, if | |
| | | | | available, SHALL | |
| | | | | override the weight. | |
| baseCID | A | NO/ | 0 . . . 1 | For the DRM Profile, | string |
| | | TO | | part of the Service or | |
| | | | | Program CID used to | |
| | | | | identify the | |
| | | | | corresponding asset | |
| | | | | within a OMA DRM | |
| | | | | 2.0 Rights Object. The | |
| | | | | Service or Program | |
| | | | | CID is obtained from | |
| | | | | the BaseCID as | |
| | | | | described in | |
| | | | | [BCAST10- | |
| | | | | ServContProt] section | |
| | | | | 5.5.1. | |
| | | | | This element is only | |
| | | | | Mandatory to support | |
| | | | | for the network and | |
| | | | | terminal in case the | |
| | | | | DRM Profile is | |
| | | | | supported [BCAST10- | |
| | | | | ServContProt]. | |
| | | | | Note: for uniqueness of | |
| | | | | the baseCID see | |
| | | | | Appendix H. | |
| emergency | A | NO/ | 0 . . . 1 | When assigned with | boolean |
| | | TO | | value ‘true‘, specifies | |
| | | | | that this service is a | |
| | | | | service of an | |
| | | | | emergency nature. This | |
| | | | | also denotes that all | |
| | | | | content items belonging | |
| | | | | to this service are | |
| | | | | contents of an | |
| | | | | emergency nature. | |
| | | | | This attribute can be | |
| | | | | used for presentation | |
| | | | | purposes to users. | |
| | | | | It is RECOMMENDED | |
| | | | | that the Terminal | |
| | | | | processes the reception | |
| | | | | of the services or | |
| | | | | content of emergency | |
| | | | | nature with high | |
| | | | | priority, and highlight | |
| | | | | their availability to | |
| | | | | user. How to order the | |
| | | | | emergency service or | |
| | | | | content is out of the | |
| | | | | scope of the | |
| | | | | specification. | |
| | | | | The default value of | |
| | | | | this attribute is ‘false’. | |
| ProtectionKeyID | E1 | NO/ | 0 . . . N | Key identifier needed | base64Binary |
| | | TO | | to access a protected | |
| | | | | service. This | |
| | | | | information allows the | |
| | | | | terminal to determine | |
| | | | | whether or not it has | |
| | | | | the correct key material | |
| | | | | to access service(s) | |
| | | | | within a PurchaseItem. | |
| | | | | In a scenario where this | |
| | | | | fragment is shared | |
| | | | | among multiple service | |
| | | | | providers, different key | |
| | | | | identifiers from the | |
| | | | | different service | |
| | | | | providers to access this | |
| | | | | specific protected | |
| | | | | service/content may be | |
| | | | | mixed in this element | |
| | | | | and the terminal | |
| | | | | SHOULD be able to | |
| | | | | sort out the key | |
| | | | | identifiers associated | |
| | | | | with the terminal's | |
| | | | | affiliated service | |
| | | | | provider based on the | |
| | | | | Key Domain ID. How | |
| | | | | this is used is out of | |
| | | | | scope of the present | |
| | | | | disclosure and is left | |
| | | | | open to various | |
| | | | | implementations. | |
| | | | | The network and | |
| | | | | terminal SHALL | |
| | | | | support this element in | |
| | | | | case the Smartcard | |
| | | | | Profile is supported | |
| | | | | [BCAST10- | |
| | | | | ServContProt]. | |
| | | | | The protection key | |
| | | | | identifiers to access a | |
| | | | | specific service or | |
| | | | | content item SHALL | |
| | | | | only be signalled in one | |
| | | | | of the following | |
| | | | | fragment types: | |
| | | | | ‘Service’, ‘Content’, | |
| | | | | ‘PurchaseItem’, | |
| | | | | ‘PurchaseData’ or | |
| | | | | ‘Access’ fragments, but | |
| | | | | not mixed. | |
| | | | | Contains the following | |
| | | | | attribute: | |
| | | | | type | |
| type | A | NM/ | 1 | Type of | unsignedByte |
| | | TM | | ProtectionKeyID: | |
| | | | | 0: ProtectionKeyID is | |
| | | | | the 5-byte long | |
| | | | | concatenation of the | |
| | | | | Key Domain ID with | |
| | | | | the Key group part of | |
| | | | | the SEK/PEK ID, | |
| | | | | where both values are | |
| | | | | as used in the | |
| | | | | Smartcard Profile | |
| | | | | [BCAST10- | |
| | | | | ServContProt]. | |
| | | | | The Key number part | |
| | | | | SHALL NOT be | |
| | | | | provided. | |
| | | | | The Terminal MAY use | |
| | | | | the Key Domain ID and | |
| | | | | Key group part of the | |
| | | | | ProtectionKeyID to | |
| | | | | determine whether it | |
| | | | | already has the SEK | |
| | | | | applicable to the related | |
| | | | | service. The Terminal | |
| | | | | MAY use this | |
| | | | | information to indicate | |
| | | | | to the user which | |
| | | | | services can currently | |
| | | | | be accessed. The | |
| | | | | Terminal SHALL not | |
| | | | | use the SEK ID in the | |
| | | | | ProtectionKeyID to | |
| | | | | request a missing SEK. | |
| | | | | It is possible for the | |
| | | | | Terminal to request | |
| | | | | missing SEK based on | |
| | | | | the information from | |
| | | | | the secure function | |
| | | | | after the STKM | |
| | | | | decryption has failed. | |
| | | | | 1-127 Reserved for | |
| | | | | future use | |
| | | | | 128-255 Reserved for | |
| | | | | proprietary use | |
| ServiceType | E1 | NM/ | 0 . . . N | Type of the service. | unsigned Byte |
| | | TM | | Allowed values are: | |
| | | | | 0 - unspecified | |
| | | | | 1 - Basic TV | |
| | | | | 2 - Basic Radio | |
| | | | | 3 - RI services | |
| | | | | 4 - Cachecast | |
| | | | | 5 - File download | |
| | | | | services | |
| | | | | 6 - Software | |
| | | | | management services | |
| | | | | 7 - Notification | |
| | | | | 8 - Service Guide | |
| | | | | 9 - Terminal | |
| | | | | Provisioning services | |
| | | | | 10 - Auxiliary Data | |
| | | | | 11-127 reserved for | |
| | | | | future use | |
| | | | | 128-255 reserved for | |
| | | | | proprietary use | |
| | | | | The mixed service | |
| | | | | types SHALL be | |
| | | | | indicated by the | |
| | | | | presence of multiple | |
| | | | | instances of | |
| | | | | ServiceType (for | |
| | | | | example, for mixed | |
| | | | | Basic TV and | |
| | | | | Cachecast, two | |
| | | | | instances of | |
| | | | | ServiceType, with | |
| | | | | values 1 and 4 are | |
| | | | | present for this | |
| | | | | ‘Service’ fragment. | |
| | | | | This element SHALL | |
| | | | | be processed by the | |
| | | | | terminal strictly for | |
| | | | | rendering to the user | |
| | | | | for example as a textual | |
| | | | | indicator, an icon, or | |
| | | | | graphic representation | |
| | | | | for the service. | |
| | | | | However, | |
| | | | | ‘ServiceType’ with | |
| | | | | value of 3 and 9 | |
| | | | | SHALL NOT be | |
| | | | | rendered and their | |
| | | | | existence SHOULD | |
| | | | | NOT be displayed to | |
| | | | | the user. If | |
| | | | | ‘ServiceType’ is 10, the | |
| | | | | associated Program | |
| | | | | Guide portion of this | |
| | | | | fragment SHOULD | |
| | | | | NOT be displayed. | |
| | | | | With value 6, i.e. | |
| | | | | sofware management | |
| | | | | services, users can | |
| | | | | select the desired | |
| | | | | software components | |
| | | | | (Eg. desktop theme, | |
| | | | | ringtone, SG navigator | |
| | | | | update) to download | |
| | | | | over broadcast channel | |
| | | | | or interaction channel. | |
| | | | | The software | |
| | | | | components provided | |
| | | | | by this sofware | |
| | | | | management service | |
| | | | | are described by | |
| | | | | ‘Content’ fragments | |
| | | | | which belong to this | |
| | | | | ‘Service’ fragment. It is | |
| | | | | not expected that | |
| | | | | terminals are able to | |
| | | | | automatically select | |
| | | | | and download software | |
| | | | | components using this | |
| | | | | type of service. | |
| | | | | If the terminal supports | |
| | | | | the ‘AuxDataTrigger’ | |
| | | | | notification type, and it | |
| | | | | supports auxiliary data | |
| | | | | download/caching for | |
| | | | | subsequent | |
| | | | | insertion/rendering to | |
| | | | | users (as described in | |
| | | | | [BCAST10-Services]), | |
| | | | | then the content items | |
| | | | | belonging to this | |
| | | | | service SHALL be | |
| | | | | downloaded and | |
| | | | | selectively cached by | |
| | | | | the terminal in | |
| | | | | accordance to the | |
| | | | | ‘AuxDataTrigger’ | |
| | | | | element of <type> = 0 | |
| | | | | (i.e. download trigger) | |
| | | | | in the Notification | |
| | | | | message (Section | |
| | | | | 5.14.3 of [BCAST10- | |
| | | | | Services]). | |
| | | | | Start of program guide | |
| | | | | The program guide | |
| | | | | elements of this | |
| | | | | fragment are grouped | |
| | | | | between the Start of | |
| | | | | program guide and end | |
| | | | | of program guide cells | |
| | | | | in this fragment. | |
| | | | | The program guide | |
| | | | | elements are for user | |
| | | | | interpretation. This | |
| | | | | enables the content | |
| | | | | creator to provide user | |
| | | | | readable information | |
| | | | | about the service. The | |
| | | | | terminal SHOULD use | |
| | | | | all declared program | |
| | | | | guide elements in this | |
| | | | | fragment for | |
| | | | | presentation to the end- | |
| | | | | user. The terminal | |
| | | | | MAY offer search, sort | |
| | | | | etc functionalities. | |
| | | | | The Program Guide | |
| | | | | consists of the | |
| | | | | following elements: | |
| | | | | Name | |
| | | | | Description | |
| | | | | AudioLanguage | |
| | | | | TextLanguage | |
| | | | | ParentalRating | |
| | | | | TargetUserProfile | |
| | | | | Genre | |
| | | | | Extension | |
| | | | | UDBAllowed | |
| Name | E1 | NM/ | 1 . . . N | Name of the Service, | string |
| | | TM | | possibly in multiple | |
| | | | | languages. The | |
| | | | | language is expressed | |
| | | | | using built-in XML | |
| | | | | attribute ‘xml:lang’ | |
| | | | | with this element. | |
| Description | E1 | NM/ | 0 . . . N | Description, possibly in | string |
| | | TM | | multiple languages. The | |
| | | | | language is expressed | |
| | | | | using built-in XML | |
| | | | | attribute ‘xml:lang’ | |
| | | | | with this element. | |
| AudioLanguage | E1 | NM/ | 0 . . . N | This element declares | string |
| | | TM | | for the end users that | |
| | | | | this service is available | |
| | | | | with an audio track | |
| | | | | corresponding to the | |
| | | | | language represented | |
| | | | | by the value of this | |
| | | | | element. | |
| | | | | The textual value of | |
| | | | | this element can be | |
| | | | | made available for the | |
| | | | | end users in different | |
| | | | | languages. In such a | |
| | | | | case the language used | |
| | | | | to represent the value | |
| | | | | of this element is | |
| | | | | signalled using the | |
| | | | | built-in XML attribute | |
| | | | | ‘xml:lang’. See section | |
| | | | | 7, Multi-language | |
| | | | | support. | |
| | | | | Contains the following | |
| | | | | attribute: | |
| | | | | languageSDPTag | |
| languageSDPTag | A | NM/ | 1 | Identifier of the audio | string |
| | | TO | | language described by | |
| | | | | the parent | |
| | | | | ‘AudioLanguage’ | |
| | | | | element as used in the | |
| | | | | media sections | |
| | | | | describing the audio | |
| | | | | track in a Session | |
| | | | | Description. | |
| | | | | The | |
| | | | | ‘languageSDPTag’ | |
| | | | | SHALL be | |
| | | | | formatted | |
| | | | | according to the | |
| | | | | rules of [RFC | |
| | | | | 3066], for the | |
| | | | | described language. | |
| | | | | Each | |
| | | | | ‘AudioLanguage’ | |
| | | | | element declaring | |
| | | | | the same audio | |
| | | | | stream SHALL | |
| | | | | have the same | |
| | | | | value of the | |
| | | | | ‘languageSDPTag’. | |
| TextLanguage | E1 | NM/ | 0 . . . N | This element declares | string |
| | | TM | | for the end user that the | |
| | | | | textual components of | |
| | | | | this service are | |
| | | | | available in the | |
| | | | | language represented | |
| | | | | by the value of this | |
| | | | | element. The textual | |
| | | | | components can be, for | |
| | | | | instance, a caption or a | |
| | | | | sub-title track. | |
| | | | | The textual value of | |
| | | | | this element can be | |
| | | | | made available for the | |
| | | | | end users in different | |
| | | | | languages. In such a | |
| | | | | case the language used | |
| | | | | to represent the value | |
| | | | | of this element is | |
| | | | | signalled using the | |
| | | | | built-in XML attribute | |
| | | | | ‘xml:lang’. See section | |
| | | | | 7 Multi-language | |
| | | | | support. | |
| | | | | The same rules and | |
| | | | | constraints as specified | |
| | | | | for the element | |
| | | | | ‘AudioLanguage’ of | |
| | | | | assigning and | |
| | | | | interpreting the | |
| | | | | attributes | |
| | | | | ‘languageSDPTag’ and | |
| | | | | ‘xml:lang’ SHALL be | |
| | | | | applied for this element | |
| | | | | also. | |
| | | | | Contains the following | |
| | | | | attribute: | |
| | | | | languageSDPTag | |
| languageSDPTag | A | NM/ | 1 | Identifier of the text | string |
| | | TO | | language described by | |
| | | | | the parent | |
| | | | | ‘TextLanguage’ | |
| | | | | element as used in the | |
| | | | | media sections | |
| | | | | describing the textual | |
| | | | | track in a Session | |
| | | | | Description. | |
| ParentalRating | E1 | NM/ | 0 . . . N | The ParentalRating | string |
| | | TM | | element defines criteria | |
| | | | | parents might use to | |
| | | | | determine whether the | |
| | | | | associated item is | |
| | | | | suitable for access by | |
| | | | | children, defined | |
| | | | | according to the | |
| | | | | regulatory requirements | |
| | | | | of the service area. | |
| | | | | The terminal SHALL | |
| | | | | support | |
| | | | | ‘ParentalRating’ being | |
| | | | | a free string, and the | |
| | | | | terminal MAY support | |
| | | | | the structured way to | |
| | | | | express the parental | |
| | | | | rating level by using | |
| | | | | the ‘ratingSystem’ and | |
| | | | | ‘ratingValueName’ | |
| | | | | attributes as defined | |
| | | | | below. | |
| | | | | Contains the following | |
| | | | | attributes: | |
| | | | | ratingSystem | |
| | | | | ratingValueName | |
| ratingSystem | A | NO/ | 0 . . . 1 | Specifies the parental | unsignedByte |
| | | TM | | rating system in use, in | |
| | | | | which context the value | |
| | | | | of the ‘ParentalRating’ | |
| | | | | element is semantically | |
| | | | | defined. This allows | |
| | | | | terminals to identify the | |
| | | | | rating system in use in | |
| | | | | a non-ambiguous | |
| | | | | manner and act | |
| | | | | appropriately. | |
| | | | | This attribute SHALL | |
| | | | | be instantiated when a | |
| | | | | rating system is used. | |
| | | | | Absence of this | |
| | | | | attribute means that no | |
| | | | | rating system is used. | |
| | | | | (i.e. the value of the | |
| | | | | ‘ParentalRating’ | |
| | | | | element is to be | |
| | | | | interpreted as a free | |
| | | | | string). | |
| | | | | If this attribute is | |
| | | | | instantiated: | |
| | | | | The value of this | |
| | | | | attribute SHALL be | |
| | | | | one of the | |
| | | | | ‘rating_type’ | |
| | | | | values as listed in | |
| | | | | the OMA BCAST | |
| | | | | Parental Rating | |
| | | | | System Registry at | |
| | | | | [OMNA]. | |
| | | | | The | |
| | | | | ‘ParentalRating’ | |
| | | | | element SHALL | |
| | | | | contain the string | |
| | | | | representation of a | |
| | | | | number that is a | |
| | | | | valid ‘rating_value’ | |
| | | | | in this particular | |
| | | | | rating system. | |
| | | | | This attribute MAY | |
| | | | | contain the value | |
| | | | | ‘10’ (OMA | |
| | | | | BCAST generic | |
| | | | | rating scheme), | |
| | | | | allowing to define a | |
| | | | | rating value in a | |
| | | | | non-registered | |
| | | | | parental rating | |
| | | | | system. In such | |
| | | | | case, the | |
| | | | | ‘ParentalRating’ | |
| | | | | element SHALL | |
| | | | | contain the string | |
| | | | | representation of a | |
| | | | | number between 1 | |
| | | | | and 255, 1 being | |
| | | | | the least and 255 | |
| | | | | being the most | |
| | | | | restrictive rating | |
| | | | | value. As these | |
| | | | | values are generic, | |
| | | | | the human-readable | |
| | | | | label of that rating | |
| | | | | value SHALL be | |
| | | | | signalled in the | |
| | | | | attribute | |
| | | | | ‘ratingValueName’. | |
| ratingValueName | A | NO/ | 0 . . . 1 | The human-readable | string |
| | | TM | | name of the rating | |
| | | | | value given by this | |
| | | | | ParentalRating element. | |
| | | | | This attribute SHALL | |
| | | | | be present in case the | |
| | | | | ‘ratingSystem’ attribute | |
| | | | | contains the value ‘10’. | |
| TargetUserProfile | E1 | NO/ | 0 . . . N | Profile attributes of the | |
| | | TO | | users whom the service | |
| | | | | is targeting at. The | |
| | | | | detailed personal | |
| | | | | attribute names and the | |
| | | | | corresponding values | |
| | | | | are specified by | |
| | | | | attributes of | |
| | | | | ‘attributeName’ and | |
| | | | | ‘attributeValue’. | |
| | | | | Amongst the possible | |
| | | | | profile attribute names | |
| | | | | are age, gender, | |
| | | | | occupation, etc. | |
| | | | | (subject to | |
| | | | | national/local rules & | |
| | | | | regulations, if present | |
| | | | | and as applicable | |
| | | | | regarding use of | |
| | | | | personal profiling | |
| | | | | information and | |
| | | | | personal data privacy). | |
| | | | | The extensible list of | |
| | | | | ‘attributeName’ and | |
| | | | | ‘attributeValue’ pairs | |
| | | | | for a particular service | |
| | | | | enables end user profile | |
| | | | | filtering and end user | |
| | | | | preference filtering of | |
| | | | | broadcast services. The | |
| | | | | terminal SHOULD be | |
| | | | | able to support | |
| | | | | ‘TargetUserProfile’ | |
| | | | | element. The terminal | |
| | | | | behavior for | |
| | | | | interpreting and acting | |
| | | | | upon | |
| | | | | ‘TargetUserProfile’ is | |
| | | | | out of the scope. | |
| | | | | It is RECOMMENDED | |
| | | | | that use of | |
| | | | | ‘TargetUserProfile’ | |
| | | | | element is an “opt-in” | |
| | | | | capability for users. | |
| | | | | Terminal settings | |
| | | | | SHOULD allow users | |
| | | | | to configure whether to | |
| | | | | input their personal | |
| | | | | profile or preference | |
| | | | | and whether to allow | |
| | | | | broadcast service to be | |
| | | | | automatically filtered | |
| | | | | based on the users' | |
| | | | | personal attributes | |
| | | | | without users' request. | |
| | | | | Contains the following | |
| | | | | attributes: | |
| | | | | attributeName | |
| | | | | attributeValue | |
| attributeName | A | NM/ | 1 | Profile attribute name | string |
| | | TM | | | |
| attributeValue | A | NM/ | 1 | Profile attribute value | string |
| | | TM | | | |
| Genre | E1 | NM/ | 0 . . . N | Classification of | string |
| | | TM | | service associated with | |
| | | | | characteristic form (e.g. | |
| | | | | comedy, drama). | |
| | | | | The OMA BCAST | |
| | | | | Service Guide allows | |
| | | | | describing the format of | |
| | | | | the Genre element in | |
| | | | | the Service Guide in | |
| | | | | two ways: | |
| | | | | The first way is to | |
| | | | | use a free string | |
| | | | | The second way is | |
| | | | | to use the “href” | |
| | | | | attributes of the | |
| | | | | Genre element to | |
| | | | | convey the | |
| | | | | information in the | |
| | | | | form of a controlled | |
| | | | | vocabulary | |
| | | | | (classification | |
| | | | | scheme as defined in | |
| | | | | [TVA-Metadata] or | |
| | | | | classification list as | |
| | | | | defined in | |
| | | | | [MIGFG]). | |
| | | | | The built-in XML | |
| | | | | attribute xml:lang | |
| | | | | MAY be used with this | |
| | | | | element to express the | |
| | | | | language. | |
| | | | | The Network MAY | |
| | | | | instantiate several | |
| | | | | different sets of ‘Genre’ | |
| | | | | element, using it as a | |
| | | | | free string or with a | |
| | | | | ‘href’ attribute. The | |
| | | | | Network SHALL | |
| | | | | ensure the different sets | |
| | | | | have equivalent and | |
| | | | | non-conflicting | |
| | | | | meaning, and the | |
| | | | | terminal SHALL select | |
| | | | | one of the sets to | |
| | | | | interpret for the end- | |
| | | | | user. | |
| | | | | Contains the following | |
| | | | | attributes: | |
| | | | | type | |
| | | | | href | |
| type | A | NO/ | 0 . . . 1 | This attribute signals | string |
| | | TO | | the level of this ‘Genre’ | |
| | | | | element. | |
| | | | | The following values | |
| | | | | are allowed: | |
| | | | | “main” | |
| | | | | “secondary” | |
| | | | | “other” | |
| href | A | NO/ | 0 . . . 1 | This attribute signals | anyURI |
| | | TO | | the controlled | |
| | | | | vocabulary used for this | |
| | | | | ‘Genre’ element. | |
| | | | | If this attribute is | |
| | | | | supported, the | |
| | | | | following applies to the | |
| | | | | support and use of | |
| | | | | classification schemes | |
| | | | | according to [TVA- | |
| | | | | Metadata]: | |
| | | | | for values of the | |
| | | | | ‘type’ attribute | |
| | | | | equal to “main” or | |
| | | | | “secondary”, the | |
| | | | | terminal MAY | |
| | | | | support levels 1-4 | |
| | | | | of the TV Anytime | |
| | | | | ContentCS | |
| | | | | classification | |
| | | | | scheme identified | |
| | | | | by the | |
| | | | | classificationScheme | |
| | | | | URI | |
| | | | | urn:tva:metadata:cs:ContentCS:2005 | |
| | | | | as defined in | |
| | | | | Annex A.8 of | |
| | | | | [TVA-Metadata] | |
| | | | | for a value of the | |
| | | | | ‘type’ attribute | |
| | | | | equal to “other”, the | |
| | | | | terminal MAY | |
| | | | | support levels 1-3 | |
| | | | | of the TV Anytime | |
| | | | | IntendedAudience- | |
| | | | | CS classification | |
| | | | | scheme identified | |
| | | | | by the | |
| | | | | classification- | |
| | | | | SchemeURI | |
| | | | | urn:tva:metadata:cs:IntendedAudienceCS:2005 | |
| | | | | as defined | |
| | | | | in Annex A.11 of | |
| | | | | [TVA-Metadata]. | |
| | | | | When the | |
| | | | | IntendedAudienceCS | |
| | | | | is provided | |
| | | | | simultaneously | |
| | | | | with an | |
| | | | | instantiation of the | |
| | | | | ‘TargetUserProfile’, | |
| | | | | the two SHALL | |
| | | | | have equivalent | |
| | | | | meaning. | |
| | | | | The network | |
| | | | | SHALL use the | |
| | | | | following URI | |
| | | | | syntax to signal | |
| | | | | terms from | |
| | | | | classification | |
| | | | | schemes: | |
| | | | | <classificationSchemeURI>“:” | |
| | | | | <termID> | |
| | | | | If this attribute is | |
| | | | | instantiated by the | |
| | | | | network, the | |
| | | | | element ‘Genre’ | |
| | | | | SHALL be an | |
| | | | | empty string and | |
| | | | | the xml:lang | |
| | | | | attribute SHALL | |
| | | | | NOT be used. | |
| | | | | If this attribute is | |
| | | | | supported, the | |
| | | | | following applies to the | |
| | | | | support and use of the | |
| | | | | classification from | |
| | | | | [MIGFG]: | |
| | | | | This classification | |
| | | | | SHALL be | |
| | | | | signalled with the | |
| | | | | URI | |
| | | | | “http://www.loc.gov/rr/mopic/miggen.html” | |
| | | | | The string value | |
| | | | | carried in the | |
| | | | | ‘Genre’ element | |
| | | | | SHALL be used to | |
| | | | | convey the actual | |
| | | | | value of the | |
| | | | | classification as | |
| | | | | given in [MIGFG] | |
| | | | | The Network MAY use | |
| | | | | the values “main” and | |
| | | | | “secondary” of the | |
| | | | | ‘type’ attribute so as to | |
| | | | | provide an ordering of | |
| | | | | two classifications | |
| | | | | applying to the same | |
| | | | | Service. | |
| | | | | Other Classification | |
| | | | | Schemes MAY be | |
| | | | | signalled with the ‘href’ | |
| | | | | attribute, however how | |
| | | | | they are used is out of | |
| | | | | scope of this | |
| | | | | specification. | |
| | | | | If this attribute is not | |
| | | | | instantiated, the | |
| | | | | ‘Genre’ element | |
| | | | | SHALL be a free | |
| | | | | string. | |
| Extension | E1 | NM/ | 0 . . . N | Additional information | |
| | | TM | | related to this fragment. | |
| | | | | Contains the following | |
| | | | | attribute: | |
| | | | | url | |
| | | | | Contains the following | |
| | | | | element: | |
| | | | | Description | |
| url | A | NM/ | 1 | URL containing | anyURI |
| | | TM | | additional information | |
| | | | | related to this fragment. | |
| Description | E2 | NM/ | 0 . . . N | Description regarding | string |
| | | TM | | the additional | |
| | | | | information which can | |
| | | | | be retrieved from a web | |
| | | | | page. The language is | |
| | | | | expressed using built-in | |
| | | | | XML attribute | |
| | | | | ‘xml:lang’ with this | |
| | | | | element | |
| UDBAllowed | E1 | NO/ | 1 | Represents whether if | boolean |
| | | TO | | this Service can be used | |
| | | | | in User Defined Bundle | |
| | | | | subscriptions/ | |
| | | | | End of program guide | |
| PreviewData- | E1 | NM/ | 0 . . . N | Reference to the | |
| Reference | | TM | | ‘PreviewData’ | |
| | | | | fragment which | |
| | | | | specifies the preview | |
| | | | | data (Eg. picture, video | |
| | | | | clip, or low-bit rate | |
| | | | | stream) associated with | |
| | | | | this service: | |
| | | | | It is possible that there | |
| | | | | are more than one | |
| | | | | ‘PreviewDataReference’ | |
| | | | | instances associated | |
| | | | | with the same | |
| | | | | fragment, in which | |
| | | | | case, the values of | |
| | | | | ‘usage’ attributes of | |
| | | | | these | |
| | | | | ‘PreviewDataReference’ | |
| | | | | instances SHALL be | |
| | | | | mutually exclusive. | |
| | | | | Contains the following | |
| | | | | attributes: | |
| | | | | idRef | |
| | | | | usage | |
| idRef | A | NM/ | 1 | Identification of the | anyURI |
| | | TM | | ‘PreviewData’ | |
| | | | | fragment which this | |
| | | | | fragment is associated | |
| | | | | with. | |
| usage | A | NM/ | 1 | Specifies the usage of | unsignedByte |
| | | TM | | the associated preview | |
| | | | | data. Possible values: | |
| | | | | 0. unspecified | |
| | | | | 1. Service-by-Service | |
| | | | | Switching | |
| | | | | 2. Service Guide | |
| | | | | Browsing | |
| | | | | 3. Service Preview | |
| | | | | 4. Barker | |
| | | | | 5. Alternative to | |
| | | | | blackout | |
| | | | | 6-127. reserved for | |
| | | | | future use | |
| | | | | 128-255. reserved for | |
| | | | | proprietary use | |
| | | | | The explanation and | |
| | | | | limitation on the above | |
| | | | | preview data usages is | |
| | | | | specified in section 5.7. | |
| BroadcastArea | E1 | NO/ | 0 . . . 1 | Broadcast area to | |
| | | TO | | include location | |
| | | | | information for BCAST | |
| | | | | contents. | |
| | | | | Contains the following | |
| | | | | attribute: | |
| | | | | polarity | |
| | | | | Contains the following | |
| | | | | elements: | |
| | | | | TargetArea | |
| | | | | lev_conf | |
| polarity | A | NO/ | 0 . . . 1 | Indication of whether | boolean |
| | | TO | | the associated target | |
| | | | | area is intended for | |
| | | | | positive or negative | |
| | | | | terminal reception of | |
| | | | | the service. | |
| | | | | If polarity = true or 1, | |
| | | | | this indicates the | |
| | | | | associated service is | |
| | | | | intended for reception | |
| | | | | by terminals located | |
| | | | | within the | |
| | | | | corresponding | |
| | | | | geographical area. | |
| | | | | (Default) | |
| | | | | If polarity = false or 0, | |
| | | | | this indicates the | |
| | | | | associated service is not | |
| | | | | intended for reception | |
| | | | | by terminals located | |
| | | | | within the | |
| | | | | corresponding | |
| | | | | geographical area. | |
| TargetArea | E2 | NO/ | 0 . . . N | The target area to | |
| | | TM | | distribute contents (as | |
| | | | | specified in the [OMA | |
| | | | | MLP] with | |
| | | | | modifications) | |
| | | | | Contains the following | |
| | | | | elements: | |
| | | | | shape | |
| | | | | cc | |
| | | | | mcc | |
| | | | | name_area | |
| | | | | ZipCode | |
| | | | | CellTargetArea | |
| | | | | Only one of the above | |
| | | | | six elements SHALL be | |
| | | | | instantiated at the same | |
| | | | | time. Implementation in | |
| | | | | XML schema using | |
| | | | | <choice>. | |
| shape | E3 | NO/ | 0 . . . 1 | Shapes used to | |
| | | TM | | represent a geographic | |
| | | | | area that describes (as | |
| | | | | specified in the [OMA | |
| | | | | MLP]) | |
| cc | E3 | NO/ | 0 . . . 1 | Country code, 1-3 | unsignedShort |
| | | TM | | digits e.g. 355 for | |
| | | | | Albania (as specified in | |
| | | | | the [OMA MLP]) | |
| mcc | E3 | NO/ | 0 . . . 1 | Mobile country code, 3 | string of three |
| | | TM | | digits e.g. 276 for | digits |
| | | | | Albania (as specified in | |
| | | | | [ITU-MCC], aligned | |
| | | | | with [OMA MLP]) | |
| name_area | E3 | NO/ | 0 . . . N | Geopolitical name of | string |
| | | TM | | area such as ‘Seoul’ (as | |
| | | | | specified in the [OMA | |
| | | | | MLP]. The instances of | |
| | | | | ‘name_area’ element | |
| | | | | differ only in language. | |
| | | | | The language is | |
| | | | | expressed using built-in | |
| | | | | XML attribute | |
| | | | | ‘xml:lang’ with this | |
| | | | | element. | |
| ZipCode | E3 | NO/ | 0 . . . 1 | Zip code | string |
| | | TM | | | |
| CellTargetArea | E3 | NO/ | 0 . . . 1 | The target area to | |
| | | TM | | distribute content | |
| | | | | specified by he BDS | |
| | | | | specific service | |
| | | | | coverage area or | |
| | | | | minimum transmit area | |
| | | | | Contains the following | |
| | | | | attribute: | |
| | | | | type | |
| | | | | Contains the following | |
| | | | | element: | |
| | | | | CellArea | |
| type | A | NM/ | 1 | Allowed values are: | unsignedByte |
| | | TM | | 0 - Unspecified | |
| | | | | 1 - 3GPP Cell Global | |
| | | | | Identifier as defined in | |
| | | | | 3GPP TS 23.003 | |
| | | | | 2 - 3GPP Routing Area | |
| | | | | Identifier (RAI) as | |
| | | | | defined in 3GPP TS | |
| | | | | 23.003 | |
| | | | | 3 - 3GPP Location | |
| | | | | Area Identifier (LAI) as | |
| | | | | defined in 3GPP TS | |
| | | | | 23.003 | |
| | | | | 4 - 3GPP Service Area | |
| | | | | Identifier (SAI) as | |
| | | | | defined in 3GPP TS | |
| | | | | 23.003 | |
| | | | | 5 - 3GPP MBMS | |
| | | | | Service Area Identity | |
| | | | | (MBMS SAI) as | |
| | | | | defined in 3GPP TS | |
| | | | | 23.003 | |
| | | | | 6 - 3GPP2 Subnet ID | |
| | | | | as defined in [3GPP2 | |
| | | | | X. S0022-A] | |
| | | | | 7 - 3GPP2 SID as | |
| | | | | defined in [3GPP2 | |
| | | | | C.S0005-D] | |
| | | | | 8 - 3GPP2 SID + NID as | |
| | | | | defined in [3GPP2 | |
| | | | | C.S0005-D] | |
| | | | | 9 - 3GPP2 | |
| | | | | SID + NID + PZID as | |
| | | | | defined in [3GPP2 | |
| | | | | C.S0005-D] | |
| | | | | 10 - 3GPP2 SID + PZID | |
| | | | | as defined in [3GPP2 | |
| | | | | C.S0005-D] | |
| | | | | 11 - DVB-H Cell ID | |
| | | | | (specified in section | |
| | | | | 6.3.4.1 of [BCAST10- | |
| | | | | DVBH-IPDC- | |
| | | | | Adaptation]) | |
| | | | | 12-127 reserved for | |
| | | | | future use | |
| | | | | 128-255 reserved for | |
| | | | | proprietary use | |
| CellArea | E4 | NM/ | 1 . . . N | The BDS specific | |
| | | TM | | transmit area given in | |
| | | | | the format as defined | |
| | | | | by type. | |
| | | | | Contains the following | |
| | | | | attribute: | |
| | | | | value | |
| | | | | Contains the following | |
| | | | | element: | |
| | | | | PP2CellID | |
| value | A | NM/ | 1 | The value of the cell | string |
| | | TM | | ID. The structure of this | |
| | | | | value depends on the | |
| | | | | value of the type | |
| | | | | attribute | |
| PP2CellID | E5 | NO/ | 0 . . . N | If type = 6, the value is | positiveInteger |
| | | TO | | Sector_ID as defined in | |
| | | | | [3GPP2 C.S0024-A] | |
| | | | | If type = 7, 8, 9 or 10, | |
| | | | | the value is BASE ID | |
| | | | | as defined in [3GPP2 | |
| | | | | C.S0002-0] | |
| | | | | 3GPP2 terminals | |
| | | | | SHALL support this | |
| | | | | element. | |
| lev_conf | E2 | NO/ | 0 . . . 1 | The target level of | unsignedByte |
| | | TM | | confidence that the | |
| | | | | terminal is indeed | |
| | | | | located within the | |
| | | | | indicated ‘TargetArea’ | |
| | | | | as defined in [OMA | |
| | | | | MLP], used in | |
| | | | | performing the service | |
| | | | | reception filtering in | |
| | | | | accordance to polarity. | |
| | | | | Valid values: 0 . . . 100 | |
| | | | | Note that lev_conf is | |
| | | | | allowed but less useful | |
| | | | | when target area | |
| | | | | corresponds to any of | |
| | | | | the allowed types of | |
| | | | | CellTargetArea, since it | |
| | | | | is presumed that air | |
| | | | | interface technology | |
| | | | | specific signalling | |
| | | | | informs the terminal | |
| | | | | whether or not it is | |
| | | | | currently located in the | |
| | | | | vicinity of the specified | |
| | | | | CellTargetArea”. | |
| TermsOfUse | E1 | NO/ | 0 . . . N | Element that declares | |
| | | TO | | there are Terms of Use | |
| | | | | associated with this | |
| | | | | fragment. | |
| | | | | Contains the textual | |
| | | | | presentation of Terms | |
| | | | | of Use or a reference to | |
| | | | | Terms of Use | |
| | | | | representation through | |
| | | | | ‘PreviewData’, and | |
| | | | | information whether | |
| | | | | user consent is required | |
| | | | | for the Terms of Use. | |
| | | | | Multiple occurrences of | |
| | | | | ‘TermsOfUse’ are | |
| | | | | allowed within this | |
| | | | | fragment, but for any | |
| | | | | two such occurrences | |
| | | | | values for elements | |
| | | | | ‘Country’ and | |
| | | | | ‘Language’ SHALL | |
| | | | | NOT be same at the | |
| | | | | same time. | |
| | | | | In addition to Terms of | |
| | | | | Use this element MAY | |
| | | | | be used for disclaimers, | |
| | | | | legal text and other | |
| | | | | pieces of information to | |
| | | | | be rendered to the user | |
| | | | | upon activation, | |
| | | | | purchase or | |
| | | | | consumption of service | |
| | | | | or content. | |
| | | | | Contains the following | |
| | | | | attributes: | |
| | | | | type | |
| | | | | id | |
| | | | | userConsentRequired | |
| | | | | Contains the following | |
| | | | | elements: | |
| | | | | Country | |
| | | | | Language | |
| | | | | PreviewDataIDRef | |
| | | | | TermsOfUseText | |
| type | A | NM/ | 1 | The way the terminal | unsignedByte |
| | | TM | | SHALL interpret the | |
| | | | | Terms of Use: | |
| | | | | 0 - Not used. | |
| | | | | 1 - Display before | |
| | | | | playout. | |
| | | | | If ‘TermsOfUse’ | |
| | | | | element of type ‘1’ is | |
| | | | | present, terminal | |
| | | | | SHALL present the | |
| | | | | Terms of Use prior to | |
| | | | | playing out content or | |
| | | | | service associated with | |
| | | | | this fragment. | |
| | | | | 2-127 reserved for | |
| | | | | future use | |
| | | | | 128-255 reserved for | |
| | | | | proprietary use | |
| id | A | NM/ | 1 | The URI uniquely | anyURI |
| | | TM | | identifying the Terms | |
| | | | | of Use. | |
| userConsentRequired | A | NM/ | 1 | Signals whether user | boolean |
| | | TM | | consent for these Terms | |
| | | | | of Use is needed. | |
| | | | | true: | |
| | | | | User consent is | |
| | | | | required for these | |
| | | | | Terms of Use and | |
| | | | | needs to be confirmed. | |
| | | | | How such confirmation | |
| | | | | is done is out of scope | |
| | | | | of this disclosure. | |
| | | | | false: | |
| | | | | User consent is not | |
| | | | | required for the Terms | |
| | | | | of Use. | |
| Country | E2 | NM/ | 0 . . . N | List of countries for | string of 3 |
| | | TM | | which the Terms of Use | digits |
| | | | | are applicable if | |
| | | | | consuming the service | |
| | | | | in that country. Each | |
| | | | | value is a Mobile | |
| | | | | Country Code | |
| | | | | according [ITU-MCC]. | |
| | | | | If this element is | |
| | | | | omitted, the Terms of | |
| | | | | Use are applicable to | |
| | | | | any country. | |
| Language | E2 | NM/ | 1 | Language in which the | string |
| | | TM | | Terms of Use is given. | |
| | | | | Value is a three | |
| | | | | character string | |
| | | | | according to ISO 639-2 | |
| | | | | alpha standard for | |
| | | | | language codes. | |
| PreviewDataIDRef | E2 | NO/ | 0 . . . 1 | Reference to the | anyURI |
| | | TM | | ‘PreviewData’ | |
| | | | | fragment which carries | |
| | | | | the representation of | |
| | | | | Terms of Use. | |
| | | | | If this element is not | |
| | | | | present, the | |
| | | | | ‘TermsOfUseText’ | |
| | | | | element SHALL be | |
| | | | | present | |
| | | | | (Implementation in | |
| | | | | XML schema using | |
| | | | | <choice>). | |
| TermsOfUseText | E2 | NO/ | 0 . . . 1 | Terms of Use text to be | string |
| | | TM | | rendered. | |
| | | | | If this element is not | |
| | | | | present the | |
| | | | | ‘PreviewDataIDRef’ | |
| | | | | this element SHALL be | |
| | | | | present | |
| | | | | (Implementation in | |
| | | | | XML schema using | |
| | | | | <choice>). | |
| PrivateExt | E1 | NO/ | 0 . . . 1 | An element serving as a | |
| | | TO | | container for | |
| | | | | proprietary or | |
| | | | | application-specific | |
| | | | | extensions. | |
| <proprietary | E2 | NO/TO | 0 . . . N | Proprietary or | |
| elements> | | | | application-specific | |
| | | | | elements that are not | |
| | | | | defined in this | |
| | | | | disclosure. | |
| | | | | These elements may | |
| | | | | further contain sub | |
| | | | | elements or attributes. | |

TABLE 1C

| Name | Type | Category | Cardinality | Description | Data Type |
|---|---|---|---|---|---|
| Content | E | | | ‘Content’ fragment | |
| | | | | Contains the following | |
| | | | | attributes: | |
| | | | | id | |
| | | | | version | |
| | | | | validFrom | |
| | | | | validTo | |
| | | | | globalContentID | |
| | | | | emergency | |
| | | | | baseCID | |
| | | | | Contains the following | |
| | | | | elements: | |
| | | | | ServiceReference | |
| | | | | ProtectionKeyID | |
| | | | | Name | |
| | | | | Description | |
| | | | | StartTime | |
| | | | | EndTime | |
| | | | | AudioLanguage | |
| | | | | TextLanguage | |
| | | | | Length | |
| | | | | ParentalRating | |
| | | | | TargetUserProfile | |
| | | | | Genre | |
| | | | | Extension | |
| | | | | UDBAllowed | |
| | | | | PreviewDataReference | |
| | | | | BroadcastArea | |
| | | | | TermsOfUse | |
| | | | | PrivateExt | |
| id | A | NM/ | 1 | ID of the ‘Content’ | anyURI |
| | | TM | | fragment. The value of | |
| | | | | this attribute SHALL be | |
| | | | | globally unique. | |
| version | A | NM/ | 1 | Version of this fragment. | unsignedInt |
| | | TM | | The newer version | |
| | | | | overrides the older one | |
| | | | | starting from the time | |
| | | | | specified by the | |
| | | | | ‘validFrom’ attribute, or | |
| | | | | as soon as it has been | |
| | | | | received if no | |
| | | | | ‘validFrom’ attribute is | |
| | | | | given. | |
| validFrom | A | NM/ | 0 . . . 1 | The first moment when | unsignedInt |
| | | TM | | this fragment is valid. If | |
| | | | | not given, the validity is | |
| | | | | assumed to have started | |
| | | | | at some time in the past. | |
| | | | | This field contains the | |
| | | | | 32bits integer part of an | |
| | | | | NTP time stamp. | |
| validTo | A | NM/ | 0 . . . 1 | The last moment when | unsignedInt |
| | | TM | | this fragment is valid. If | |
| | | | | not given, the validity is | |
| | | | | assumed to end in | |
| | | | | undefined time in the | |
| | | | | future. | |
| | | | | This field contains the | |
| | | | | 32bits integer part of an | |
| | | | | NTP time stamp. | |
| globalContentID | A | NM/ | 0 . . . 1 | The globally unique | anyURI |
| | | TM | | identifier identifying the | |
| | | | | content that this | |
| | | | | ‘Content’ fragment | |
| | | | | describes. | |
| | | | | If the content item | |
| | | | | identified by this | |
| | | | | attribute belongs to the | |
| | | | | ‘Auxiliary Data’ service | |
| | | | | type, it is expected that | |
| | | | | ‘globalContentID’ will | |
| | | | | have a matching value in | |
| | | | | the ‘GlobalContentID’ | |
| | | | | sub-element of an | |
| | | | | ‘AuxDataTrigger’ | |
| | | | | notification message | |
| | | | | whose <type> = 0 (i.e. | |
| | | | | download trigger) as | |
| | | | | specified in (Section | |
| | | | | 5.14.3 of [BCAST10- | |
| | | | | Services]). | |
| emergency | A | NO/ | 0 . . . 1 | When assigned with | boolean |
| | | TO | | value ‘true’, specifies | |
| | | | | that this content is | |
| | | | | content of emergency | |
| | | | | nature. This attribute can | |
| | | | | be used for presentation | |
| | | | | purposes to users. | |
| | | | | It is RECOMMENDED | |
| | | | | that the Terminal | |
| | | | | processes the reception | |
| | | | | of the services or content | |
| | | | | of emergency nature | |
| | | | | with high priority, and | |
| | | | | highlights their | |
| | | | | availability to user. How | |
| | | | | to order the emergency | |
| | | | | service or content is out | |
| | | | | of the scope of the | |
| | | | | specification. | |
| | | | | The default value of this | |
| | | | | attribute is ‘false’. | |
| baseCID | A | NO/ | 0 . . . 1 | For the DRM Profile, | string |
| | | TO | | part of the Service or | |
| | | | | Program CID used to | |
| | | | | identify the | |
| | | | | corresponding asset | |
| | | | | within an OMA DRM | |
| | | | | 2.0 Rights Object. The | |
| | | | | Service or Program CID | |
| | | | | is obtained from the | |
| | | | | BaseCID as described in | |
| | | | | [BCAST10- | |
| | | | | ServContProt], section | |
| | | | | 5.5.1]. | |
| | | | | In case this element is | |
| | | | | present the terminal | |
| | | | | SHALL use this element | |
| | | | | to identify the | |
| | | | | corresponding asset | |
| | | | | within an OMA DRM | |
| | | | | 2.0 Rights Object, | |
| | | | | instead of the | |
| | | | | baseCID(s) of the | |
| | | | | ‘Service’ fragment(s) | |
| | | | | this ‘Content’ fragment | |
| | | | | is associated with. | |
| | | | | In case this ‘Content’ | |
| | | | | fragment contains a | |
| | | | | reference to a ‘Service’ | |
| | | | | fragment this element | |
| | | | | MAY be present when: | |
| | | | | this ‘Content’ | |
| | | | | fragment is | |
| | | | | referenced by a | |
| | | | | ‘PurchaseItem’ | |
| | | | | fragment or when | |
| | | | | a ‘PurchaseItem’ | |
| | | | | fragment references | |
| | | | | a ‘Schedule’ | |
| | | | | fragment that | |
| | | | | references this | |
| | | | | ‘Content’ fragment, | |
| | | | | to identify the | |
| | | | | corresponding asset | |
| | | | | within an OMA DRM | |
| | | | | 2.0 Rights Object, in | |
| | | | | case the network | |
| | | | | supports the DRM | |
| | | | | profile. | |
| | | | | In case this ‘Content’ | |
| | | | | fragment does not | |
| | | | | contain a reference to a | |
| | | | | ‘Service’ fragment this | |
| | | | | element SHALL be | |
| | | | | present when: | |
| | | | | this ‘Content’ | |
| | | | | fragment is | |
| | | | | referenced by a | |
| | | | | ‘PurchaseItem’ | |
| | | | | fragment or when | |
| | | | | a ‘PurchaseItem’ | |
| | | | | fragment references | |
| | | | | a ‘Schedule’ | |
| | | | | fragment that | |
| | | | | references this | |
| | | | | ‘Content’ fragment | |
| | | | | to identify the | |
| | | | | corresponding asset | |
| | | | | within an OMA DRM | |
| | | | | 2.0 Rights Object, in | |
| | | | | case the network | |
| | | | | supports the DRM | |
| | | | | profile. | |
| | | | | The network and | |
| | | | | terminal SHALL support | |
| | | | | this element in case the | |
| | | | | DRM Profile is | |
| | | | | supported [BCAST10- | |
| | | | | ServContProt]. | |
| | | | | Note: for uniqueness of | |
| | | | | the baseCID see | |
| | | | | Appendix H. | |
| ServiceReference | E1 | NM/ | 0 . . . N | Reference to the | |
| | | TM | | ‘Service’ fragment(s) to | |
| | | | | which the ‘Content’ | |
| | | | | fragment belongs. | |
| | | | | Contains the following | |
| | | | | attributes: | |
| | | | | idRef | |
| | | | | weight | |
| | | | | Note: If the content item | |
| | | | | described by this | |
| | | | | ‘Content’ fragment | |
| | | | | belongs to a service of | |
| | | | | the ‘Auxiliary Data’ | |
| | | | | service type, then this | |
| | | | | content item SHOULD | |
| | | | | NOT be described in the | |
| | | | | Program Guide. More, | |
| | | | | specifically, for | |
| | | | | ‘Auxiliary Data’ services, | |
| | | | | those elements and | |
| | | | | attributes in the Program | |
| | | | | Guide portion of this | |
| | | | | fragment that allow a | |
| | | | | minimum cardinality of | |
| | | | | 0 SHALL not be | |
| | | | | instantiated. | |
| idRef | A | NM/ | 1 | Identification of the | anyURI |
| | | TM | | ‘Service’ fragment | |
| | | | | which this ‘Content’ | |
| | | | | fragment is associated | |
| | | | | with. | |
| weight | A | NM/ | 0 . . . 1 | Intended order of | unsignedShort |
| | | TM | | display of this ‘Content’ | |
| | | | | fragment relative to | |
| | | | | other ‘Content’ | |
| | | | | fragments belonging to | |
| | | | | the same service as | |
| | | | | presented to the end | |
| | | | | user. The order of | |
| | | | | display is by increasing | |
| | | | | Weight value (i.e., | |
| | | | | content with lowest | |
| | | | | Weight is displayed | |
| | | | | first). | |
| | | | | Default: 65535 | |
| ProtectionKeyID | E1 | NO/ | 0 . . . N | Key identifier needed to | base64Binary |
| | | TO | | access protected content. | |
| | | | | This information allows | |
| | | | | the terminal to | |
| | | | | determine whether it has | |
| | | | | the correct key material | |
| | | | | to access content item(s) | |
| | | | | within a PurchaseItem. | |
| | | | | In a scenario where this | |
| | | | | fragment is shared | |
| | | | | among multiple service | |
| | | | | providers, different key | |
| | | | | identifiers from the | |
| | | | | different service | |
| | | | | providers to access this | |
| | | | | specific protected | |
| | | | | content item may be | |
| | | | | mixed in this element | |
| | | | | and the terminal | |
| | | | | SHOULD be able to sort | |
| | | | | out the key identifiers | |
| | | | | associated with the | |
| | | | | terminal's affiliated | |
| | | | | service provider based | |
| | | | | on the Key Domain ID. | |
| | | | | How this is used is out | |
| | | | | of scope of the present | |
| | | | | disclosure and is open to | |
| | | | | various | |
| | | | | implementations. | |
| | | | | The network and | |
| | | | | terminal SHALL support | |
| | | | | this element in case the | |
| | | | | Smartcard Profile is | |
| | | | | supported [BCAST10- | |
| | | | | ServContProt]. | |
| | | | | The protection key | |
| | | | | identifiers to access a | |
| | | | | specific service or | |
| | | | | content item SHALL | |
| | | | | only be signalled in one | |
| | | | | of the following | |
| | | | | fragment types: | |
| | | | | ‘Service’, ‘Content’, | |
| | | | | ‘PurchaseItem’; | |
| | | | | ‘PurchaseData’ or | |
| | | | | ‘Access’ fragments, but | |
| | | | | not mixed. | |
| | | | | Contains the following | |
| | | | | attributes: | |
| | | | | type | |
| | | | | min | |
| | | | | max | |
| type | A | NM/ | 1 | Type of | unsignedByte |
| | | TM | | ProtectionKeyID: | |
| | | | | 0: ProtectionKeyID is | |
| | | | | the 5-byte long | |
| | | | | concatenation of the Key | |
| | | | | Domain ID with the Key | |
| | | | | group part of the | |
| | | | | SEK/PEK ID, where | |
| | | | | both values are as used | |
| | | | | in the Smartcard Profile | |
| | | | | [BCAST10- | |
| | | | | ServContProt]. | |
| | | | | The Key number part | |
| | | | | SHALL NOT be | |
| | | | | provided. | |
| | | | | The Terminal MAY use | |
| | | | | the Key Domain ID and | |
| | | | | Key group part of the | |
| | | | | ProtectionKeyID to | |
| | | | | determine whether it | |
| | | | | already has either the | |
| | | | | SEK applicable to | |
| | | | | access the service to | |
| | | | | which this content item | |
| | | | | belongs, or the PEK | |
| | | | | applicable to this content | |
| | | | | item. The Terminal | |
| | | | | MAY use this | |
| | | | | information to indicate | |
| | | | | to the user which content | |
| | | | | items can currently be | |
| | | | | accessed. The Terminal | |
| | | | | SHALL not use the | |
| | | | | SEK/PEK ID in the | |
| | | | | ProtectionKeyID to | |
| | | | | request a missing SEK | |
| | | | | or PEK. It is possible for | |
| | | | | the Terminal to request | |
| | | | | missing SEK or PEK | |
| | | | | based on the information | |
| | | | | from the secure function | |
| | | | | after the STKM | |
| | | | | decryption has been | |
| | | | | failed. | |
| | | | | 1-127 Reserved for | |
| | | | | future use | |
| | | | | 128-255 Reserved for | |
| | | | | proprietary use | |
| min | A | NM/ | 0 . . . 1 | Indicates the lower | nonnegative- |
| | | TM | | validity value of the key | IInteger |
| | | | | needed to access the | |
| | | | | service/content. | |
| | | | | For type 0, corresponds | |
| | | | | to the value of the | |
| | | | | lowest timestamp (32 | |
| | | | | bits) of an STKM | |
| | | | | needed to access the | |
| | | | | service/content, as used | |
| | | | | in the Smartcard Profile | |
| | | | | [BCAST10- | |
| | | | | ServContProt] | |
| max | A | NM/ | 0 . . . 1 | Indicates the higher | nonnegative- |
| | | TM | | validity value of the key | IInteger |
| | | | | needed to access the | |
| | | | | service/content. | |
| | | | | For type 0, corresponds | |
| | | | | to the value of the | |
| | | | | highest timestamp (32 | |
| | | | | bits) of an STKM | |
| | | | | needed to access the | |
| | | | | service/content, as used | |
| | | | | in the Smartcard Profile | |
| | | | | [BCAST10- | |
| | | | | ServContProt]. | |
| | | | | Start of program guide | |
| | | | | The program guide | |
| | | | | elements of this | |
| | | | | fragment are grouped | |
| | | | | between the Start of | |
| | | | | program guide and end | |
| | | | | of program guide cells in | |
| | | | | this fragment. | |
| | | | | The program guide | |
| | | | | elements are for user | |
| | | | | interpretation. This | |
| | | | | enables the content | |
| | | | | creator to provide user | |
| | | | | readable information | |
| | | | | about the service. The | |
| | | | | terminal SHOULD use | |
| | | | | all declared program | |
| | | | | guide elements in this | |
| | | | | fragment for | |
| | | | | presentation to the end- | |
| | | | | user. The terminal MAY | |
| | | | | offer search, sort etc | |
| | | | | functionalities. | |
| | | | | The Program Guide | |
| | | | | consists of the following | |
| | | | | elements: | |
| | | | | Name | |
| | | | | Description | |
| | | | | StartTime | |
| | | | | EndTime | |
| | | | | AudioLanguage | |
| | | | | TextLanguage | |
| | | | | Length | |
| | | | | ParentalRating | |
| | | | | TargetUserProfile | |
| | | | | Genre | |
| | | | | Extension | |
| | | | | UDBAllowed | |
| Name | E1 | NM/ | 1 . . . N | Name of the ‘Content’ | string |
| | | TM | | fragment, possibly in | |
| | | | | multiple languages. The | |
| | | | | language is expressed | |
| | | | | using built-in XML | |
| | | | | attribute ‘xml:lang’ with | |
| | | | | this element. | |
| Description | E1 | NM/ | 0 . . . N | Description, possibly in | string |
| | | TM | | multiple languages. | |
| | | | | The language is | |
| | | | | expressed using built-in | |
| | | | | XML attribute | |
| | | | | ‘xml:lang’ with this | |
| | | | | element. | |
| StartTime | E1 | NM/ | 0 . . . 1 | The start time of the | dateTime |
| | | TM | | content which is for | |
| | | | | presentation purposes to | |
| | | | | the end user, expressed | |
| | | | | in UTC, using | |
| | | | | ‘dateTime’ XML built- | |
| | | | | in datatype. | |
| | | | | This element is | |
| | | | | applicable for scheduled | |
| | | | | rendering of non- | |
| | | | | Cachecast content. For | |
| | | | | Cachecast content, the | |
| | | | | start time is defined by | |
| | | | | the ‘startTime’ attribute | |
| | | | | of the | |
| | | | | ‘PresentationWindow’ | |
| | | | | element in the | |
| | | | | ‘Schedule’ fragment. | |
| EndTime | E1 | NM/ | 0 . . . 1 | The end time of the | dateTime |
| | | TM | | content which is for | |
| | | | | presentation purposes to | |
| | | | | the end user, expressed | |
| | | | | in UTC, using | |
| | | | | ‘dateTime’ XML built- | |
| | | | | in datatype. | |
| | | | | This element is | |
| | | | | applicable for scheduled | |
| | | | | rendering of non- | |
| | | | | Cachecast content. For | |
| | | | | Cachecast content, the | |
| | | | | end time is defined by | |
| | | | | the ‘endTime’ attribute | |
| | | | | of the | |
| | | | | ‘PresentationWindow’ | |
| | | | | element in the | |
| | | | | ‘Schedule’ fragment. | |
| AudioLanguage | E1 | NM/ | 0 . . . N | This element declares | string |
| | | TM | | for the end users that | |
| | | | | this content is available | |
| | | | | with an audio stream | |
| | | | | corresponding to the | |
| | | | | language represented by | |
| | | | | the value of this | |
| | | | | element. | |
| | | | | The textual value of this | |
| | | | | element can be made | |
| | | | | available for the end | |
| | | | | users in different | |
| | | | | languages. In such a | |
| | | | | case the language used | |
| | | | | to represent the value of | |
| | | | | this element is signalled | |
| | | | | using the built-in XML | |
| | | | | attribute ‘xml:lang’. See | |
| | | | | section 7 Multi-language | |
| | | | | support. | |
| | | | | Contains the following | |
| | | | | attribute: | |
| | | | | languageSDPTag | |
| languageSDPTag | A | NM/ | 1 | Identifier of the audio | string |
| | | TO | | language described by | |
| | | | | the parent | |
| | | | | ‘AudioLanguage’ | |
| | | | | element as used in the | |
| | | | | media sections | |
| | | | | describing the audio | |
| | | | | track in a Session | |
| | | | | Description. | |
| | | | | The | |
| | | | | ‘languageSDPTag’ | |
| | | | | SHALL be | |
| | | | | formatted according | |
| | | | | to the rules of [RFC | |
| | | | | 3066], for the | |
| | | | | described language. | |
| | | | | Each | |
| | | | | ‘AudioLanguage’ | |
| | | | | element declaring | |
| | | | | the same audio | |
| | | | | stream SHALL have | |
| | | | | the same value of | |
| | | | | the | |
| | | | | ‘languageSDPTag’. | |
| TextLanguage | E1 | NM/ | 0 . . . N | This element declares | string |
| | | TM | | for the end user that the | |
| | | | | textual components of | |
| | | | | this content are available | |
| | | | | in the language | |
| | | | | represented by the value | |
| | | | | of this element. The | |
| | | | | textual components can | |
| | | | | be, for instance, a | |
| | | | | caption or a sub-title | |
| | | | | track. | |
| | | | | The textual value of this | |
| | | | | element can be made | |
| | | | | available for the end | |
| | | | | users in different | |
| | | | | languages. In such a | |
| | | | | case the language used | |
| | | | | to represent the value of | |
| | | | | this element is signalled | |
| | | | | using the built-in XML | |
| | | | | attribute ‘xml:lang. See | |
| | | | | section 7 Multi-language | |
| | | | | support. | |
| | | | | The same rules and | |
| | | | | constraints as specified | |
| | | | | for the element | |
| | | | | ‘AudioLanguage’ of | |
| | | | | assigning and | |
| | | | | interpreting the | |
| | | | | attributes’ | |
| | | | | languageSDPTag’ and | |
| | | | | ‘xml:lang’ SHALL be | |
| | | | | applied for this element | |
| | | | | also. | |
| | | | | Contains the following | |
| | | | | attribute: | |
| | | | | languageSDPTag | |
| languageSDPTag | A | NM/ | 1 | Identifier of the text | string |
| | | TO | | language described by | |
| | | | | the parent | |
| | | | | ‘TextLanguage’ element | |
| | | | | as used in the media | |
| | | | | sections describing the | |
| | | | | textual track in a Session | |
| | | | | Description. | |
| Length | E1 | NM/ | 0 . . . 1 | Duration of the A/V | duration |
| | | TM | | content declared | |
| ParentalRating | E1 | NM/ | 0 . . . N | The ParentalRating | string |
| | | TM | | element defines criteria | |
| | | | | parents may use to | |
| | | | | determine whether the | |
| | | | | associated item is | |
| | | | | suitable for access by | |
| | | | | children, defined | |
| | | | | according to the | |
| | | | | regulatory requirements | |
| | | | | of the service area. | |
| | | | | The parental rating level | |
| | | | | defined for ‘Content’ | |
| | | | | fragment overrides the | |
| | | | | rating level defined for | |
| | | | | the corresponding | |
| | | | | ‘Service’ fragment | |
| | | | | during the validity of the | |
| | | | | ‘Schedule’ fragment. | |
| | | | | If there are multiple | |
| | | | | content items associated | |
| | | | | with a ‘Schedule’ | |
| | | | | fragment with different | |
| | | | | parental ratings, then the | |
| | | | | one with the most | |
| | | | | restrictive parental rating | |
| | | | | overrides the others. | |
| | | | | The terminal SHALL | |
| | | | | support ‘ParentalRating’ | |
| | | | | being a free string, and | |
| | | | | the terminal MAY | |
| | | | | support the structured | |
| | | | | way to express the | |
| | | | | parental rating level by | |
| | | | | using the ‘ratingSystem’ | |
| | | | | and ‘ratingValueName’ | |
| | | | | attributes as defined | |
| | | | | below. | |
| | | | | Contains the following | |
| | | | | attributes: | |
| | | | | ratingSystem | |
| | | | | ratingValueName | |
| ratingSystem | A | NO/ | 0 . . . 1 | Specifies the parental | unsignedByte |
| | | TM | | rating system in use, in | |
| | | | | which context the value | |
| | | | | of the ‘ParentalRating’ | |
| | | | | element is semantically | |
| | | | | defined. This allows | |
| | | | | terminals to identify the | |
| | | | | rating system in use in a | |
| | | | | non-ambiguous manner | |
| | | | | and act appropriately. | |
| | | | | This attribute SHALL be | |
| | | | | instantiated when a | |
| | | | | rating system is used. | |
| | | | | Absence of this attribute | |
| | | | | means that no rating | |
| | | | | system is used (i.e. the | |
| | | | | value of the | |
| | | | | ‘ParentalRating’ element | |
| | | | | is to be interpreted as a | |
| | | | | free swing). | |
| | | | | If this attribute is | |
| | | | | instantiated: | |
| | | | | The value of this | |
| | | | | attribute SHALL be | |
| | | | | one of the | |
| | | | | ‘rating_type’ values | |
| | | | | as listed in the OMA | |
| | | | | BCAST Parental | |
| | | | | Rating System | |
| | | | | Registry at | |
| | | | | [OMNA]. | |
| | | | | The ‘ParentalRating’ | |
| | | | | element SHALL | |
| | | | | contain the string | |
| | | | | representation of a | |
| | | | | number that is a | |
| | | | | valid ‘rating_value’ | |
| | | | | in this particular | |
| | | | | rating system. | |
| | | | | This attribute MAY | |
| | | | | contain the value | |
| | | | | ‘10’ (OMA BCAST | |
| | | | | generic rating | |
| | | | | scheme), allowing to | |
| | | | | define a rating value | |
| | | | | in a non-registered | |
| | | | | parental rating | |
| | | | | system. In such case, | |
| | | | | the ‘ParentalRating’ | |
| | | | | element SHALL | |
| | | | | contain the string | |
| | | | | representation of a | |
| | | | | number between 1 | |
| | | | | and 255, 1 being the | |
| | | | | least and 255 being | |
| | | | | the most restrictive | |
| | | | | rating value. As | |
| | | | | these values are | |
| | | | | generic, the human- | |
| | | | | readable label of that | |
| | | | | rating value SHALL | |
| | | | | be signalled in the | |
| | | | | attribute | |
| | | | | ‘ratingValue | |
| | | | | Name’. | |
| ratingValueName | A | NO/ | 0 . . . 1 | The human-readable | string |
| | | TM | | name of the rating value | |
| | | | | given by this | |
| | | | | ParentalRating element. | |
| | | | | This attribute SHALL be | |
| | | | | present in case the | |
| | | | | ‘ratingSystem’ attribute | |
| | | | | contains the value ‘10’. | |
| TargetUserProfile | E1 | NO/ | 0 . . . N | Profile attributes of the | |
| | | TO | | users whom the content | |
| | | | | is targeting at. The | |
| | | | | detailed personal | |
| | | | | attribute names and the | |
| | | | | corresponding values are | |
| | | | | specified by attributes of | |
| | | | | ‘attributeName’ and | |
| | | | | ‘attributeValue’. | |
| | | | | Amongst the possible | |
| | | | | profile attribute names | |
| | | | | are age, gender, | |
| | | | | occupation, etc. (subject | |
| | | | | to national/local rules & | |
| | | | | regulations, if present | |
| | | | | and as applicable | |
| | | | | regarding use of | |
| | | | | personal profiling | |
| | | | | information and personal | |
| | | | | data privacy). | |
| | | | | The extensible list of | |
| | | | | ‘attributeName’ and | |
| | | | | ‘attributeValue’ pairs for | |
| | | | | a particular content | |
| | | | | enables end user profile | |
| | | | | filtering and end user | |
| | | | | preference filtering of | |
| | | | | broadcast contents. The | |
| | | | | terminal SHOULD be | |
| | | | | able to support | |
| | | | | ‘TargetUserProfile’ | |
| | | | | element. The terminal | |
| | | | | behavior for interpreting | |
| | | | | and acting upon | |
| | | | | ‘TargetUserProfile’ is | |
| | | | | out of the scope. | |
| | | | | It is RECOMMENDED | |
| | | | | that use of | |
| | | | | ‘TargetUserProfile’ | |
| | | | | element is an “opt-in” | |
| | | | | capability for users. | |
| | | | | Terminal settings | |
| | | | | SHOULD allow users to | |
| | | | | configure whether to | |
| | | | | input their personal | |
| | | | | profile or preference and | |
| | | | | whether to allow | |
| | | | | broadcast content to be | |
| | | | | automatically filtered | |
| | | | | based on the users' | |
| | | | | personal attributes | |
| | | | | without users' request. | |
| | | | | Contains the following | |
| | | | | attributes: | |
| | | | | attributeName | |
| | | | | attributeValue | |
| attributeName | A | NM/ | 1 | Profile attribute name. | string |
| | | TM | | | |
| attributeValue | A | NM/ | 1 | Profile attribute value. | string |
| | | TM | | | |
| Genre | E1 | NM/ | 0 . . . N | Classification of content | string |
| | | TM | | associated with | |
| | | | | characteristic form (e.g. | |
| | | | | comedy, drama). | |
| | | | | The OMA BCAST | |
| | | | | Service Guide allows | |
| | | | | describing the format of | |
| | | | | the Genre element in the | |
| | | | | Service Guide in two | |
| | | | | ways: | |
| | | | | The first way is to | |
| | | | | use a free string | |
| | | | | The second way is | |
| | | | | to use the “href” | |
| | | | | attributes of the | |
| | | | | Genre element to | |
| | | | | convey the | |
| | | | | information in the | |
| | | | | form of a controlled | |
| | | | | vocabulary | |
| | | | | (classification | |
| | | | | scheme as defined in | |
| | | | | [TVA-Metadata] or | |
| | | | | classification list as | |
| | | | | defined in | |
| | | | | [MIGFG]). | |
| | | | | The built-in XML | |
| | | | | attribute xml:lang MAY | |
| | | | | be used with this | |
| | | | | element to express the | |
| | | | | language. | |
| | | | | The Network MAY | |
| | | | | instantiate several | |
| | | | | different sets of ‘Genre’ | |
| | | | | element, using it as a | |
| | | | | free string or with a | |
| | | | | ‘href’ attribute. The | |
| | | | | Network SHALL ensure | |
| | | | | the different sets have | |
| | | | | equivalent and non- | |
| | | | | conflicting meaning, and | |
| | | | | the terminal SHALL | |
| | | | | select one of the sets to | |
| | | | | interpret for the end- | |
| | | | | user. | |
| | | | | Contains the following | |
| | | | | attributes: | |
| | | | | type | |
| | | | | href | |
| type | A | NO/ | 0 . . . 1 | This attribute signals the | string |
| | | TO | | level of this ‘Genre’ | |
| | | | | element. | |
| | | | | The following values are | |
| | | | | allowed: | |
| | | | | “main” | |
| | | | | “secondary” | |
| | | | | “other” | |
| href | A | NO/ | 0 . . . 1 | This attribute signals the | anyURI |
| | | TO | | controlled vocabulary | |
| | | | | used for this ‘Genre’ | |
| | | | | element. | |
| | | | | If this attribute is | |
| | | | | supported, the following | |
| | | | | applies to the support | |
| | | | | and use of classification | |
| | | | | schemes according to | |
| | | | | [TVA-Metadata]: | |
| | | | | for values of the | |
| | | | | ‘type’ attribute | |
| | | | | equal to “main” or | |
| | | | | “secondary”, the | |
| | | | | terminal MAY | |
| | | | | support levels 1-4 of | |
| | | | | the TV Anytime | |
| | | | | ContentCS | |
| | | | | classification | |
| | | | | scheme identified by | |
| | | | | the classification- | |
| | | | | SchemeURI | |
| | | | | urn:tva:metadata:cs:ContentCS:2005 | |
| | | | | as | |
| | | | | defined in Annex | |
| | | | | A.8 of [TVA- | |
| | | | | Metadata] | |
| | | | | for a value of the | |
| | | | | ‘type’ attribute equal | |
| | | | | to “other”, the | |
| | | | | terminal MAY | |
| | | | | support levels 1-3 of | |
| | | | | the TV Anytime | |
| | | | | Intended- | |
| | | | | AudienceCS | |
| | | | | classification | |
| | | | | scheme identified by | |
| | | | | the classification- | |
| | | | | SchemeURI | |
| | | | | urn:tva:metadata:cs:IntendedAudienceCS:2005 | |
| | | | | as defined in | |
| | | | | Annex A.11 of | |
| | | | | [TVA-Metadata]. | |
| | | | | When the Intended- | |
| | | | | AudienceCS is | |
| | | | | provided | |
| | | | | simultaneously with | |
| | | | | an instantiation of | |
| | | | | the ‘TargetUser- | |
| | | | | Profile’, the two | |
| | | | | SHALL have | |
| | | | | equivalent meaning. | |
| | | | | The network | |
| | | | | SHALL use the | |
| | | | | following URI | |
| | | | | syntax to signal | |
| | | | | terms from | |
| | | | | classification | |
| | | | | schemes: | |
| | | | | <classification- | |
| | | | | SchemeURI> “:” | |
| | | | | <termID> | |
| | | | | If this attribute is | |
| | | | | instantiated by the | |
| | | | | network, the element | |
| | | | | ‘Genre’ SHALL be | |
| | | | | an empty string and | |
| | | | | the xml:lang | |
| | | | | attribute SHALL | |
| | | | | NOT be used. | |
| | | | | If this attribute is | |
| | | | | supported, the following | |
| | | | | applies to the support | |
| | | | | and use of the | |
| | | | | classification from | |
| | | | | [MIGFG]: | |
| | | | | This classification | |
| | | | | SHALL be signalled | |
| | | | | with the URI | |
| | | | | “http://www.loc.gov/rr/mopic/miggen.html” | |
| | | | | The string value | |
| | | | | carried in the | |
| | | | | ‘Genre’ element | |
| | | | | SHALL be used to | |
| | | | | convey the actual | |
| | | | | value of the | |
| | | | | classification as | |
| | | | | given in [MIGFG] | |
| | | | | The Network MAY | |
| | | | | use the values | |
| | | | | “main” and | |
| | | | | “secondary” of the | |
| | | | | ‘type’ attribute so as | |
| | | | | to provide an | |
| | | | | ordering of two | |
| | | | | classifications | |
| | | | | applying to the same | |
| | | | | Service. | |
| | | | | Other Classification | |
| | | | | Schemes MAY be | |
| | | | | signalled with the ‘href’ | |
| | | | | attribute, however how | |
| | | | | they are used is out of | |
| | | | | scope of this disclosure . . . | |
| | | | | If this attribute is not | |
| | | | | instantiated, the ‘Genre’ | |
| | | | | element SHALL be a | |
| | | | | free string. | |
| Extension | E1 | NM/ | 0 . . . N | Additional information | |
| | | TM | | related to this fragment. | |
| | | | | Contains the following | |
| | | | | attribute: | |
| | | | | url | |
| | | | | Contains the following | |
| | | | | element: | |
| | | | | Description | |
| url | A | NM/ | 1 | URL containing | anyURI |
| | | TM | | additional information | |
| | | | | related to this fragment. | |
| Description | E2 | NM/ | 0 . . . N | Description regarding | string |
| | | TM | | the additional | |
| | | | | information which can | |
| | | | | be retrieved from a web | |
| | | | | page. The language is | |
| | | | | expressed using built-in | |
| | | | | XML attribute | |
| | | | | ‘xml:lang’ with this | |
| | | | | element | |
| UDBAllowed | E1 | NO/ | 1 | Represents whether if | boolean |
| | | TO | | this Content can be used | |
| | | | | in User Defined Bundle | |
| | | | | subscriptions/ | |
| | | | | End of program guide | |
| PreviewData- | E1 | NM/ | 0 . . . N | Reference to the | |
| Reference | | TM | | ‘PreviewData’ fragment | |
| | | | | which specifies the | |
| | | | | preview data (Eg. | |
| | | | | picture, video clip, or | |
| | | | | low-bit rate stream) | |
| | | | | associated with this | |
| | | | | content. | |
| | | | | It is possible that there | |
| | | | | are more than one | |
| | | | | PreviewDataReference | |
| | | | | instances associated with | |
| | | | | the same fragment, in | |
| | | | | which case, the values of | |
| | | | | “usage” attributes of | |
| | | | | these | |
| | | | | PreviewDataReference | |
| | | | | instances SHALL be | |
| | | | | different. | |
| | | | | Contains the following | |
| | | | | attributes: | |
| | | | | idRef | |
| | | | | usage | |
| idRef | A | NM/ | 1 | Identification of the | anyURI |
| | | TM | | ‘PreviewData’ fragment | |
| | | | | which this fragment is | |
| | | | | associated with. | |
| usage | A | NM/ | 1 | Specifies the usage of | unsignedByte |
| | | TM | | the associated preview | |
| | | | | data. Possible values: | |
| | | | | 0. unspecified | |
| | | | | 1. Service-by-Service | |
| | | | | Switching | |
| | | | | 2. Service Guide | |
| | | | | Browsing | |
| | | | | 3. Service Preview | |
| | | | | 4. Barker | |
| | | | | 5. Alternative to | |
| | | | | blackout | |
| | | | | 6-127. reserved for | |
| | | | | future use | |
| | | | | 128-255. reserved for | |
| | | | | proprietary use | |
| | | | | The explanation and | |
| | | | | limitation on the above | |
| | | | | preview data usages is | |
| | | | | specified in section 5.7. | |
| BroadcastArea | E1 | NO/ | 0 . . . 1 | Broadcast area to | |
| | | TO | | include location | |
| | | | | information for BCAST | |
| | | | | contents | |
| | | | | Contains the following | |
| | | | | attribute: | |
| | | | | polarity | |
| | | | | Contains the following | |
| | | | | elements: | |
| | | | | TargetArea | |
| | | | | lev_conf | |
| polarity | A | NO/ | 0 . . . 1 | Indication of whether | boolean |
| | | TO | | the associated target area | |
| | | | | is intended for positive | |
| | | | | or negative terminal | |
| | | | | reception of the content | |
| | | | | item. | |
| | | | | If polarity = true or 1, | |
| | | | | this indicates the | |
| | | | | associated content item | |
| | | | | is intended for reception | |
| | | | | by terminals located | |
| | | | | within the corresponding | |
| | | | | geographical area. | |
| | | | | (Default) | |
| | | | | If polarity = false or 0, | |
| | | | | this indicates the | |
| | | | | associated content item | |
| | | | | is not intended for | |
| | | | | reception by terminals | |
| | | | | located within the | |
| | | | | corresponding | |
| | | | | geographical area. | |
| TargetArea | E2 | NO/ | 0 . . . N | The target area to | |
| | | TM | | distribute contents (as | |
| | | | | specified in the [OMA | |
| | | | | MLP] with | |
| | | | | modifications) | |
| | | | | Contains the following | |
| | | | | elements: | |
| | | | | shape | |
| | | | | cc | |
| | | | | mcc | |
| | | | | name_area | |
| | | | | ZipCode | |
| | | | | CellTargetArea | |
| | | | | Only one of the above | |
| | | | | six elements SHALL be | |
| | | | | instantiated at the same | |
| | | | | time. Implementation in | |
| | | | | XML schema using | |
| | | | | <choice>. | |
| shape | E3 | NO/ | 0 . . . 1 | Shapes used to represent | |
| | | TM | | a geographic area that | |
| | | | | describes (as specified in | |
| | | | | the [OMA MLP]) | |
| cc | E3 | NO/ | 0 . . . 1 | Country code as | unsignedShort |
| | | TM | | specified in [OMA | |
| | | | | MLP], e.g. 355 for | |
| | | | | Albania | |
| mcc | E3 | NO/ | 0 . . . 1 | Mobile country code, 3 | string of three |
| | | TM | | digits e.g. 276 for | digits |
| | | | | Albania (as specified in | |
| | | | | [ITU-MCC], aligned | |
| | | | | with [OMA MLP]) | |
| name_area | E3 | NO/ | 0 . . . N | Geopolitical name of | string |
| | | TM | | area such as ‘Seoul’ (as | |
| | | | | specified in the [OMA | |
| | | | | MLP]). The instances of | |
| | | | | ‘name_area’ element | |
| | | | | differ only in language. | |
| | | | | The language is | |
| | | | | expressed using built-in | |
| | | | | XML attribute | |
| | | | | ‘xml:lang’ with this | |
| | | | | element. | |
| ZipCode | E3 | NO/ | 0 . . . 1 | Zip code | string |
| | | TM | | | |
| CellTargetArea | E3 | NO/ | 0 . . . 1 | The target area to | |
| | | TM | | distribute content | |
| | | | | specified by the BDS | |
| | | | | specific service coverage | |
| | | | | area or minimum | |
| | | | | transmit area | |
| | | | | Contains the following | |
| | | | | attribute: | |
| | | | | type | |
| | | | | Contains the following | |
| | | | | element: | |
| | | | | CellArea | |
| type | A | NM/ | 1 | Allowed values are: | unsignedByte |
| | | TM | | 0 - Unspecified | |
| | | | | 1 - 3GPP Cell Global | |
| | | | | Identifier as defined in | |
| | | | | 3GPP TS 23.003 | |
| | | | | 2 - 3GPP Routing Area | |
| | | | | Identifier (RAI) as | |
| | | | | defined in 3GPP TS | |
| | | | | 23.003 | |
| | | | | 3 - 3GPP Location Area | |
| | | | | Identifier (LAI) as | |
| | | | | defined in 3GPP TS | |
| | | | | 23.003 | |
| | | | | 4 - 3GPP Service Area | |
| | | | | Identifier (SAI) as | |
| | | | | defined in 3GPP TS | |
| | | | | 23.003 | |
| | | | | 5 - 3GPP MBMS | |
| | | | | Service Area Identity | |
| | | | | (MBMS SAI) as defined | |
| | | | | in 3GPP TS 23.003 | |
| | | | | 6 - 3GPP2 Subnet ID as | |
| | | | | defined in [3GPP2 | |
| | | | | X.S0022-A] | |
| | | | | 7 - 3GPP2 SID as | |
| | | | | defined in [3GPP2 | |
| | | | | C.S0005-D] | |
| | | | | 8 - 3GPP2 SID + NID as | |
| | | | | defined in [3GPP2 | |
| | | | | C.S0005-D] | |
| | | | | 9 - 3GPP2 | |
| | | | | SID + NID + PZID as | |
| | | | | defined in [3GPP2 | |
| | | | | C.S0005-D] | |
| | | | | 10 - 3GPP2 SID + PZID | |
| | | | | as defined in [3GPP2 | |
| | | | | C.S0005-D] | |
| | | | | 11 - DVB-H Cell ID | |
| | | | | (specified in section | |
| | | | | 6.3.4.1 of [BCAST10- | |
| | | | | DVBH-IPDC- | |
| | | | | Adaptation])10-127 | |
| | | | | reserved for future use | |
| | | | | 128-255 reserved for | |
| | | | | proprietary use | |
| CellArea | E4 | NM/ | 1 . . . N | The BDS specific | |
| | | TM | | transmit area given in | |
| | | | | the format as defined by | |
| | | | | type. | |
| | | | | Contains the following | |
| | | | | attribute: | |
| | | | | Value | |
| | | | | Contains the following | |
| | | | | element: | |
| | | | | PP2CellID | |
| value | A | NM/ | 1 | The value of the cell ID. | string |
| | | TM | | The structure of this | |
| | | | | value depends on the | |
| | | | | value of the type | |
| | | | | attribute. | |
| PP2CellID | E5 | NO/ | 0 . . . N | If type = 6, the value is | positiveInteger |
| | | TO | | Sector_ID as defined in | |
| | | | | [3GPP2 C.S0024-A] | |
| | | | | If type = 7, 8, 9 or 10, | |
| | | | | the value is BASE ID as | |
| | | | | defined in [3GPP2 | |
| | | | | C.S0002-0] | |
| | | | | Note: See relevant BDS | |
| | | | | specification for the data | |
| | | | | type of this element | |
| | | | | Note: 3GPP2 terminals | |
| | | | | SHALL support this | |
| | | | | element | |
| lev_conf | E2 | NO/ | 0 . . . 1 | The target-level of | unsignedByte |
| | | TM | | confidence that the | |
| | | | | terminal is indeed | |
| | | | | located within the | |
| | | | | indicated ‘TargetArea’ | |
| | | | | as defined in [OMA | |
| | | | | MLP], used in | |
| | | | | performing the content | |
| | | | | reception filtering in | |
| | | | | accordance to polarity. | |
| | | | | Valid values: 0 . . . 100 | |
| | | | | Note that lev_conf is | |
| | | | | allowed but less useful | |
| | | | | when target area | |
| | | | | corresponds to any of | |
| | | | | the allowed types of | |
| | | | | CellTargetArea, since it | |
| | | | | is presumed that air | |
| | | | | interface technology | |
| | | | | specific signalling | |
| | | | | informs the terminal | |
| | | | | whether or not it is | |
| | | | | currently located in the | |
| | | | | vicinity of the specified | |
| | | | | CellTargetArea”. | |
| TermsOfUse | E1 | NO/ | 0 . . . N | Element that declares | |
| | | TO | | there are Terms of Use | |
| | | | | associated with this | |
| | | | | fragment. | |
| | | | | Contains the textual | |
| | | | | presentation of Terms of | |
| | | | | Use or a reference to | |
| | | | | Terms of Use | |
| | | | | representation through | |
| | | | | ‘PreviewData’, and | |
| | | | | information whether | |
| | | | | user consent is required | |
| | | | | for the Terms of Use. | |
| | | | | Multiple occurrences of | |
| | | | | ‘TermsOfUse’ are | |
| | | | | allowed within this | |
| | | | | fragment, but for any | |
| | | | | two such occurrences | |
| | | | | values for elements | |
| | | | | ‘Country’ and | |
| | | | | ‘Language’ SHALL | |
| | | | | NOT be same at the | |
| | | | | same time. | |
| | | | | In addition to Terms of | |
| | | | | Use this element MAY | |
| | | | | be used for disclaimers, | |
| | | | | legal text and other | |
| | | | | pieces of information to | |
| | | | | be rendered to the user | |
| | | | | upon activation, | |
| | | | | purchase or consumption | |
| | | | | of service or content. | |
| | | | | Contains the following | |
| | | | | attributes: | |
| | | | | type | |
| | | | | id | |
| | | | | userConsentRequired | |
| | | | | Contains the following | |
| | | | | elements: | |
| | | | | Country | |
| | | | | Language | |
| | | | | PreviewDataIDRef | |
| | | | | TermsOfUseText | |
| type | A | NM/ | 1 | The way the terminal | unsignedByte |
| | | TM | | SHALL interpret the | |
| | | | | Terms of Use: | |
| | | | | 0 - | |
| | | | | Not used. | |
| | | | | 1 - Display before | |
| | | | | playout. | |
| | | | | If ‘TermsOfUse’ | |
| | | | | element of type ‘1’ is | |
| | | | | present, terminal | |
| | | | | SHALL present the | |
| | | | | Terms of Use prior to | |
| | | | | playing out content or | |
| | | | | service associated with | |
| | | | | this fragment. | |
| | | | | 2-127 reserved for | |
| | | | | future use | |
| | | | | 128-255 reserved for | |
| | | | | proprietary use | |
| id | A | NM/ | 1 | The URI uniquely | anyURI |
| | | TM | | identifying the Terms of | |
| | | | | Use. | |
| userConsent- | A | NM/ | 1 | Signals whether user | boolean |
| Required | | TM | | consent for these Terms | |
| | | | | of Use is needed. | |
| | | | | true: | |
| | | | | User consent is required | |
| | | | | for these Terms of Use | |
| | | | | and needs to be | |
| | | | | confirmed. How such | |
| | | | | confirmation is done is | |
| | | | | out of scope of this | |
| | | | | specification. | |
| | | | | false: | |
| | | | | User consent is not | |
| | | | | required for the Terms | |
| | | | | of Use. | |
| Country | E2 | NM/ | 0 . . . N | List of countries for | string of 3 |
| | | TM | | which the Terms of Use | digits |
| | | | | are applicable if | |
| | | | | consuming the content | |
| | | | | in that country. Each | |
| | | | | value is a Mobile | |
| | | | | Country Code according | |
| | | | | to [ITU-MCC]. | |
| | | | | If this element is | |
| | | | | omitted, the Terms of | |
| | | | | Use are applicable to | |
| | | | | any country. | |
| Language | E2 | NM/ | 1 | Language in which the | string |
| | | TM | | Terms of Use is given. | |
| | | | | Value is a three | |
| | | | | character string | |
| | | | | according to ISO 639-2 | |
| | | | | alpha standard for | |
| | | | | language codes. | |
| PreviewDataIDRef | E2 | NO/ | 0 . . . 1 | Reference to the | anyURI |
| | | TM | | ‘PreviewData’ fragment | |
| | | | | which carries the | |
| | | | | representation of Terms | |
| | | | | of Use. | |
| | | | | If this element is not | |
| | | | | present, the | |
| | | | | ‘TermsOfUseText’ | |
| | | | | element SHALL be | |
| | | | | present(Implementation | |
| | | | | in XML schema using | |
| | | | | <choice>). | |
| TermsOfUseText | E2 | NO/ | 0 . . . 1 | Terms of Use text to be | string |
| | | TM | | rendered. | |
| | | | | If this element is not | |
| | | | | present, the | |
| | | | | ‘PreviewDataIDRef’ | |
| | | | | element SHALL be | |
| | | | | present (Implementation | |
| | | | | in XML schema using | |
| | | | | <choice>)t. | |
| PrivateExt | E1 | NO/ | 0 . . . 1 | An element serving as a | |
| | | TO | | container for proprietary | |
| | | | | or application-specific | |
| | | | | extensions. | |
| <proprietary | E2 | NO/TO | 0 . . . N | Proprietary or | |
| elements> | | | | application-specific | |
| | | | | elements that are not | |
| | | | | defined in this | |
| | | | | disclosure. These | |
| | | | | elements may further | |
| | | | | contain sub-elements or | |
| | | | | attributes. | |

Still referring to FIG. 3, in step 305, the user selects desired services or contents from the service guide illustrated by the terminal 301. As the user selects services or contents other than services or contents included in the bundles provided by the BCAST service provider, the terminal 301 creates a bundle(s) desired by the user. When the user defined bundle is created in step 305, the terminal 301 transmits a user defined bundle subscription request to the BSM 303 in step 306. The user defined bundle subscription request message is transmitted after adding the following elements to the existing service subscription request message defined in the BCAST.

A UserDefinedBundle element is used to indicate that a request for a user defined bundle exists in the user defined bundle subscription request message.

A UDBService element indicates an identifier of a service that the user desires to select from the service guide and add to the user defined bundle.

A notification element is used to determine whether to receive a notification message for the service selected by the user.

A UDBcontent element indicates an identifier of a content that the user desires to select from the service guide and add to the user defined bundle.

PurchaseItemID is used when the user desires to add the bundles provided by the service provider to the bundle created by the user.

A format of the user defined bundle subscription request message is illustrated in Table 2, and the description and uses of elements not stated above are well defined in the BCAST.

TABLE 2

| Name | Type | Category | Cardinality | Description | Data Type |
|---|---|---|---|---|---|
| ServiceRequest | E | | | Service Request Message to | |
| | | | | subscribe or purchase | |
| | | | | PurchaseItem | |
| | | | | Contains the following | |
| | | | | attributes: | |
| | | | | requestID | |
| | | | | Contains the following | |
| | | | | elements: | |
| | | | | UserID | |
| | | | | DeviceID | |
| | | | | ServiceEncryptionProtocol | |
| | | | | PurchaseItem | |
| | | | | DrmProfileSpecificPart | |
| | | | | SmartcardProfileSpecificPart | |
| | | | | UserDefinedBundle | |
| | | | | Note: The Service Request | |
| | | | | message MAY contain either | |
| | | | | the DrmProfileSpecificPart or | |
| | | | | SmartcardProfileSpecificPart, | |
| | | | | but not both. Furthermore, in | |
| | | | | the case of the Smartcard | |
| | | | | Profile, the | |
| | | | | ‘SmartcardProfileSpecificPart’ | |
| | | | | SHALL be omitted if the | |
| | | | | message is used for the | |
| | | | | purpose of subscription or | |
| | | | | purchase, and SHALL be | |
| | | | | included if the message is | |
| | | | | used to request delivery of | |
| | | | | SEK(s)/PEK(s). | |
| | | | | Note: PurchaseItem and | |
| | | | | UserDefinedBundle | |
| | | | | SHOULD not be present in | |
| | | | | the same ‘ServiceRequest’ | |
| | | | | message. | |
| requestID | A | O | 0 . . . 1 | Identifier for the Service | unsignedInt |
| | | | | request message. | |
| UserID | E1 | O | 0 . . . N | The user identity known to | string |
| | | | | the BSM. | |
| | | | | For DRM profile, in case of | |
| | | | | roaming this element SHALL | |
| | | | | be included, otherwise it | |
| | | | | MAY be included. If it is | |
| | | | | missing, the network SHALL | |
| | | | | be able to identify the user | |
| | | | | with other means. | |
| | | | | For Smartcard profile, this | |
| | | | | element SHALL be omitted, | |
| | | | | and the user identity SHALL | |
| | | | | be provided by the network | |
| | | | | with HTTP DIGEST | |
| | | | | authentication procedure | |
| | | | | defined in section 6.6. | |
| | | | | Contains the following | |
| | | | | attributes: | |
| | | | | type | |
| type | A | M | 1 | Specifies the type of User ID. | unsignedByte |
| | | | | Allowed values are: | |
| | | | | 0 - username defined in [RFC | |
| | | | | 2865] | |
| | | | | 1 - IMSI | |
| | | | | 2 - URI | |
| | | | | 3 - IMPI | |
| | | | | 4 - MSISDN | |
| | | | | 5 - MIN | |
| | | | | 6-127 reserved for future use | |
| | | | | 128-255 reserved for | |
| | | | | proprietary use | |
| DeviceID | E1 | O | 0 . . . N | A unique device | string |
| | | | | identification known to the | |
| | | | | BSM. This element SHALL | |
| | | | | be included when the device | |
| | | | | supports the DRM profile. In | |
| | | | | this case, the device shall not | |
| | | | | allow the user to modify the | |
| | | | | DeviceID. | |
| | | | | Contains the following | |
| | | | | attributes: | |
| | | | | type | |
| type | A | M | 1 | Specifies the type of Device | unsignedByte |
| | | | | ID. Allowed values are | |
| | | | | 0 - DVB Device ID | |
| | | | | 1 - 3GPP Device ID | |
| | | | | (IMEI)[3GPP TS 23.003] | |
| | | | | 2 - 3GPP2 Device ID | |
| | | | | (MEID)[3GPP2 C.S0072] | |
| | | | | 3-127 reserved for future use | |
| | | | | 128-255 reserved for | |
| | | | | proprietary use | |
| Service- | E1 | O | 0 . . . N | Lists each service encryption | string |
| Encryption | | | | protocol supported by the | |
| Protocol | | | | device, including the | |
| | | | | mandatory ones. Defined | |
| | | | | values: “ipsec”, “srtp”, and | |
| | | | | “ISMACryp”. The device is | |
| | | | | allowed to include more | |
| | | | | identifiers, however | |
| | | | | depending on the protocols | |
| | | | | supported by the network | |
| | | | | they may be ignored. | |
| | | | | Note: This element is only | |
| | | | | included in the message if a | |
| | | | | service is to be delivered over | |
| | | | | Interaction channel. | |
| Purchase | E1 | O | 0 . . . N | Contains the list and price of | |
| Item | | | | items the user wants to order | |
| | | | | and the list of services the | |
| | | | | user wants to subscribe | |
| | | | | notification. | |
| | | | | Contains the following | |
| | | | | attributes: | |
| | | | | globalIDRef | |
| | | | | Contains the following | |
| | | | | elements: | |
| | | | | PurchaseDataReference | |
| | | | | Service | |
| | | | | Note: Either or both the | |
| | | | | PurchaseItem or | |
| | | | | UserDefinedBundle element | |
| | | | | must be present in this | |
| | | | | message. | |
| globalIDRef | A | M | 1 | The identifier of the Purchase | anyURI |
| | | | | Item. The Purchase Item | |
| | | | | identifier is advertised in the | |
| | | | | PurchaseItem fragment of the | |
| | | | | Service Guide as | |
| | | | | GlobalPurchaseItemID and is | |
| | | | | inserted in this message in the | |
| | | | | same format. | |
| PurchaseData | E2 | O | 0 . . . 1 | Contains the price | |
| Reference | | | | information. | |
| | | | | This specifies the | |
| | | | | PurchaseData fragment in the | |
| | | | | Service Guide which is to be | |
| | | | | used for this subscription. | |
| | | | | Contains the following | |
| | | | | attribute | |
| | | | | idRef | |
| | | | | Contains the following | |
| | | | | Element: | |
| | | | | Price | |
| idRef | A | M | 1 | References the identifiers of | anyURI |
| | | | | PurchaseData Fragment | |
| | | | | advertised in Service Guide. | |
| Price | E3 | O | 0 . . . 1 | The price of the Purchase | decimal |
| | | | | Item known to the user from | |
| | | | | Service Guide. If | |
| | | | | PurchaseData in the Service | |
| | | | | Guide contains multiple price | |
| | | | | entries by currency, this | |
| | | | | element should be specified | |
| | | | | to indicate to the BSM the | |
| | | | | entry desired by the user. | |
| | | | | Contains the following | |
| | | | | attribute: | |
| | | | | currency | |
| currency | A | O | 0 . . . 1 | Specifies the currency codes | string |
| | | | | defined in ISO 4217 | |
| | | | | international currency codes. | |
| UserConsent | E2 | O | 0 . . . 1 | Signals whether user agreed | boolean |
| Answer | | | | to the Terms of Use as | |
| | | | | represented by id of the | |
| | | | | related TermsOfUse element. | |
| | | | | true: User agrees the terms | |
| | | | | of the Terms of Use. | |
| | | | | false: User disagrees the | |
| | | | | terms of the Terms of Use. | |
| | | | | If this element is not present | |
| | | | | the interpretation is that the | |
| | | | | user has not read or | |
| | | | | understood the Terms of Use. | |
| id | A | M | 1 | The URI uniquely identifying | anyURI |
| | | | | the Terms of Use this | |
| | | | | ‘UserConsentAnswer’ relates | |
| | | | | to. | |
| Service | E2 | O | 0 . . . N | Reference of the Service. | |
| | | | | This element is only used for | |
| | | | | subscribing service-specific | |
| | | | | Notification | |
| | | | | Contains the following | |
| | | | | attributes: | |
| | | | | globalIDRef | |
| | | | | notification | |
| | | | | Note: This element is only | |
| | | | | used for the purpose of | |
| | | | | subscribing to service- | |
| | | | | specific Notification. In | |
| | | | | addition, this element should | |
| | | | | not be confused with the | |
| | | | | MBMS User Service ID (the | |
| | | | | latter is the equivalent | |
| | | | | MBMS designation for the | |
| | | | | concatenation of the attributes | |
| | | | | ‘PurchaseItemID.@gobalIDRef’ | |
| | | | | and | |
| | | | | ‘PurchaseData.@idRef’ in | |
| | | | | BCAST. | |
| globalIDRef | A | M | 1 | Unique ID of the Service, as | anyURI |
| | | | | represented by the | |
| | | | | GlobalServiceID. It is used to | |
| | | | | identify the Service. | |
| notification | A | M | 1 | Subscription to receive | boolean |
| | | | | Notification Message related | |
| | | | | to the Service over Interaction | |
| | | | | Channel. If notification = true, | |
| | | | | it means Notification over | |
| | | | | Interaction Channel is | |
| | | | | subscribed. If | |
| | | | | notification = false, it means | |
| | | | | Notification over Interaction | |
| | | | | Channel should not be | |
| | | | | delivered. | |
| DrmProfile | E1 | O | 0 . . . 1 | Service & Content Protection | |
| SpecificPart | | | | DRM-profile specific part. | |
| | | | | This part is MANDATORY | |
| | | | | to support for DRM Profile, | |
| | | | | and is not applicable to the | |
| | | | | Smartcard Profile. | |
| | | | | Contains the following | |
| | | | | attributes: | |
| | | | | rightsIssuerURI | |
| | | | | Contains the following | |
| | | | | element: | |
| | | | | BroadcastMode | |
| rightsIssuerURI | A | O | 0 . . . 1 | ID of the rights issuer | anyURI |
| | | | | associated with the BSM. | |
| Broadcast | E2 | O | 0 . . . 1 | Indicates whether or not the | boolean |
| Mode | | | | device supports the optional | |
| | | | | broadcast mode of operation | |
| | | | | for rights acquisition, in | |
| | | | | addition to the interactive | |
| | | | | mode of operation. | |
| Smartcard- | E1 | O | 0 . . . 1 | Service & Content Protection | |
| Profile | | | | Smartcard Profile specific | |
| SpecificPart | | | | part. This part is | |
| | | | | MANDATORY to support | |
| | | | | for the Smartcard Profile, and | |
| | | | | is not applicable to the DRM | |
| | | | | Profile. | |
| | | | | Contains the following | |
| | | | | elements: | |
| | | | | ProtectionkeyID | |
| | | | | Note: This message is used to | |
| | | | | submit a request for SEK(s) | |
| | | | | or PEK(s) associated with a | |
| | | | | specific range of TEK values, | |
| | | | | due to unavailability of that | |
| | | | | key in the BCAST Terminal, | |
| | | | | necessary to enable play-back | |
| | | | | of protected recording. | |
| ProtectionKey- | E2 | M | 1 . . . N | The 7-byte long | Unsigned |
| ID | | | | concatenation of | Long |
| | | | | KeyDomainID and SEK/PEK | |
| | | | | ID corresponding to the | |
| | | | | content for which the SEK(s) | |
| | | | | or PEK(s) is requested. | |
| | | | | Contains the following | |
| | | | | attributes: | |
| | | | | timestampMin | |
| | | | | timestampMax | |
| timestamp Min | A | O | 0 . . . 1 | The lower bound of the range | hexBinary |
| | | | | of STKM timestamp values | |
| | | | | (4 bytes) for which the SEK | |
| | | | | or PEK is requested. | |
| timestamp Max | A | O | 0 . . . 1 | The upper bound of the range | hexBinary |
| | | | | of STKM timestamp values | |
| | | | | (4 bytes) for which the SEK | |
| | | | | or PEK is requested. | |
| UserDefined- | E1 | O | 0 . . . 1 | List of content and services | |
| Bundle | | | | requested to be bundled by | |
| | | | | the user | |
| | | | | Contains the following | |
| | | | | elements: | |
| | | | | UDBService | |
| | | | | UDBContent | |
| | | | | Note: Either or both the | |
| | | | | PurchaseItem or | |
| | | | | UserDefinedBundle element | |
| | | | | must be present in this | |
| | | | | message. | |
| UDBService | E2 | O | 0 . . . N | Service to be added to User | anyURI |
| | | | | Defined Bundle | |
| | | | | Contains the following | |
| | | | | attribute: | |
| | | | | UDBnotification | |
| UDB- | A | M | 1 | To receive Notification | boolean |
| notification | | | | Message related to the | |
| | | | | Service over Interaction | |
| | | | | Channel. If notification = true, | |
| | | | | it means Notification over | |
| | | | | Interaction Channel is | |
| | | | | subscribed. If | |
| | | | | notification = false, it means | |
| | | | | Notification over Interaction | |
| | | | | Channel should not be | |
| | | | | delivered | |
| UDBContent | E2 | O | 0 . . . N | Content to be added to User | anyURI |
| | | | | Defined Bundle | |
| PurchaseItem | E2 | O | 0 . . . N | Purchase Item to be added to | anyURI |
| | | | | User Defined Bundle | |

Still referring to FIG. 3, upon receipt of the user defined bundle subscription request message in step 306, the BSM 303 determines whether to accept the bundle requested by the user in step 307. If the BSM 303 cannot handle the user request, the BSM 303 transmits a user defined bundle subscription response message with unacceptability information to in step 310.

However, when the BSM 303 may support the user defined bundle service requested by the user, the BSM 303 creates a purchase inquiry request message (or a price negotiation request message), and transmits it to the terminal 301 in step 308. The purchase inquiry request message may include price information for the user defined bundle service or contents. A format of the purchase inquiry request message is illustrated in Table 3.

TABLE 3

| Name | Type | Category | Cardinality | Description | Data Type |
|---|---|---|---|---|---|
| PriceNegotiation | E | | | User Defined Bundle Price | |
| Request | | | | Negotiation Request | |
| | | | | Contains the following | |
| | | | | attributes: | |
| | | | | requestID | |
| | | | | Contains the following | |
| | | | | elements: | |
| | | | | UDBPrice | |
| requestID | A | O | 0 . . . 1 | Identifier for the | unsignedInt |
| | | | | corresponding | |
| | | | | PriceNegotiationRequest | |
| | | | | message. | |
| UDBPrice | E1 | M | 1 . . . N | Price information the User | decimal |
| | | | | Defined Bundle that a user | |
| | | | | has requested. | |
| | | | | Contains the following | |
| | | | | attribute: | |
| | | | | validTo | |
| | | | | currency | |
| validTo | A | O | 0 . . . 1 | The last moment when this | unsignedInt |
| | | | | price information is valid. | |
| | | | | If not given, the validity is | |
| | | | | assumed to end in | |
| | | | | undefined time in the | |
| | | | | future. This field expressed | |
| | | | | as the first 32bits integer | |
| | | | | part of NTP time stamps. | |
| currency | A | O | 0 . . . 1 | Specifies the currency | string |
| | | | | codes defined in ISO 4217 | |
| | | | | international currency | |
| | | | | codes. If not given, value of | |
| | | | | price is amount of Tokens. | |
| Subscription- | E1 | M | 1 | Specifies the subscription | duration |
| Period | | | | period for the | |
| | | | | UserDefinedBundle. | |
| TermsOfUse | E1 | O | 0 . . . 1 | Element that declares there | |
| | | | | are Terms of Use associated | |
| | | | | with the | |
| | | | | ‘UserDefinedBundle’ this | |
| | | | | ‘PriceNegotiationRequest’ | |
| | | | | relates to. | |
| | | | | Contains the textual | |
| | | | | presentation of Terms of | |
| | | | | Use or a reference to Terms | |
| | | | | of Use representation | |
| | | | | through ‘PreviewData’, and | |
| | | | | information whether user | |
| | | | | consent is required for the | |
| | | | | Terms of Use. | |
| | | | | Multiple occurrences of | |
| | | | | ‘TermsOfUse’ are allowed | |
| | | | | within this message, but for | |
| | | | | any two such occurrences | |
| | | | | values for elements | |
| | | | | “Country” and “Language” | |
| | | | | SHALL NOT be same at | |
| | | | | the same time. | |
| | | | | Contains the following | |
| | | | | attributes: | |
| | | | | type | |
| | | | | id | |
| | | | | userConsent- | |
| | | | | Required | |
| | | | | Contains the following sub- | |
| | | | | elements: | |
| | | | | Country | |
| | | | | Language | |
| | | | | PreviewDataIDRef | |
| | | | | TermsOfUseText | |
| type | A | M | 1 | The way the terminal | unsignedByte |
| | | | | SHALL interpret the Terms | |
| | | | | of Use: | |
| | | | | 1 - Display before | |
| | | | | purchasing or subscribing. | |
| | | | | If ‘TermsOfUse’ element of | |
| | | | | type ‘1’ is present, terminal | |
| | | | | SHALL render the Terms | |
| | | | | of Use prior to initiating | |
| | | | | purchase or subscription | |
| | | | | request related | |
| | | | | PurchaseItem associated | |
| | | | | with this message. | |
| | | | | 2 - Display before playout. | |
| | | | | If ‘TermsOfUse’ element of | |
| | | | | type ‘2’ is present, terminal | |
| | | | | SHALL present the Terms | |
| | | | | of Use prior to playing out | |
| | | | | content or service | |
| | | | | associated this message. | |
| id | A | M | 1 | The URI uniquely | anyURI |
| | | | | identifying the Terms of | |
| | | | | Use. | |
| userConsent | A | M | 1 | Signals whether user | boolean |
| Required | | | | consent for these Terms of | |
| | | | | Use is needed. | |
| | | | | true: | |
| | | | | User consent is required for | |
| | | | | these Terms of Use and | |
| | | | | needs to be confirmed in | |
| | | | | the subscription/purchase | |
| | | | | request message related to | |
| | | | | the PurchaseItem associated | |
| | | | | with this message. | |
| | | | | false: | |
| | | | | User consent is not required | |
| | | | | for the Terms of Use. | |
| Country | E2 | M | 1 . . . N | List of countries for which | string |
| | | | | the Terms of Use is | |
| | | | | applicable. Each value is a | |
| | | | | three character string | |
| | | | | according to ISO 3166-1 | |
| | | | | alpha-3 | |
| Language | E2 | M | 1 | Language in which the | string |
| | | | | Terms of Use is given. | |
| | | | | Value is a three character | |
| | | | | string according to ISO | |
| | | | | 639-2 alpha standard for | |
| | | | | language codes. | |
| PreviewData- | E2 | O | 0 . . . N | Reference to the | anyURI |
| IDRef | | | | PreviewData fragment | |
| | | | | which carries the | |
| | | | | representation of legal text. | |
| | | | | If this element is not | |
| | | | | present, the | |
| | | | | ‘TermsOfUseText’ SHALL | |
| | | | | be present. | |
| TermsOfUseText | E2 | O | 0 . . . 1 | Terms of Use text to be | string |
| | | | | rendered. | |
| | | | | If ‘PreviewDataIDRef’ | |
| | | | | element is present under the | |
| | | | | ‘TermsOfUse’ this element | |
| | | | | SHALL NOT be present. | |

A “PriceNegotiationRequest” element denotes a message for providing purchase price information of the user defined bundle requested by the user. Among elements of the purchase inquiry request message, a requestID element is used to identify the message, an UDBPrice element includes information on a purchase price of the user defined bundle requested by the user, a “validTo” element denotes a valid term available by the purchase price provided through the purchase inquiry request message, and a “currency” element denotes a unit of the purchase price provided. A “SubscriptionPeriod” element denotes a valid subscription period of the user defined bundle subscription-requested by the user.

Further, a “TermOfUse” element denotes service subscription terms, and a “type” element denotes the type of terms of use. An “id” element denotes a unique identifier in the terms of use, and a “userConsentRequired” element denotes whether user consent is required. Country and language elements indicate country and language for the terms of use, respectively. A PreviewDataIDRef element is used to display the terms of use through separate PreviewData, and a “TermsofUseText” element denotes the actual terms of use in text.

Upon receipt of the purchase inquiry request message in step 308, the terminal 301 informs the user of the price presented by the BSM 303, and then transmits a purchase inquiry response message (or a price negotiation response message) to the BSM 303 in step 309 to indicate whether the user intends to subscribe to the user defined bundle service. A format of the purchase inquiry response message is illustrated in Table 4.

TABLE 4

| Name | Type | Category | Cardinality | Description | Data Type |
|---|---|---|---|---|---|
| Price- | E | | | User Defined Bundle Price | |
| Negotiation | | | | Negotiation Response | |
| Response | | | | Contains the following attributes: | |
| | | | | requestID | |
| | | | | subscribe | |
| | | | | userConsent | |
| requestID | A | O | 0 . . . 1 | Identifier for the corresponding | unsigned |
| | | | | PriceNegotiationResponse message. | Int |
| subscribe | A | M | 1 | Signals whether user has agreed to the | boolean |
| | | | | pricing of the User Defined Bundle by | |
| | | | | and BSM and agreed to subscribe to | |
| | | | | the service | |
| userConsent | A | O | 0 . . . 1 | Signals user consent if request in | boolean |
| | | | | PriceNegotiationRequest message. | |

A “PriceNegotiationResponse” element denotes a message for providing purchase price information of the user defined bundle requested by the user. A requestID element is used to identify the message, and a “subscribe” element indicates whether the user has decided its subscription in agreement or disagreement with the price of the user defined bundle service, presented by the BSM 303. A “userConsent” element denotes an answer to the case where the user has consented to the terms of use in the purchase inquiry request message.

The user defined bundle subscription response message transmitted in step 310 is a user defined bundle response message with which the BSM 303 finally indicates a response to the subscription request for the user defined bundle. A format of the user defined bundle response message indicating a response to the subscription request for the user defined bundle is illustrated in Table 5. Some elements in the existing subscription request message defined in the BCAST are added thereto.

TABLE 5

| Name | Type | Category | Cardinality | Description | Data Type |
|---|---|---|---|---|---|
| ServiceResponse | E | | | Service Response Message | |
| | | | | Contains the following | |
| | | | | attributes: | |
| | | | | requestID | |
| | | | | globalStatusCode | |
| | | | | adaptationMode | |
| | | | | Contains the following | |
| | | | | elements: | |
| | | | | PurchaseItem | |
| | | | | DrmProfileSpecificPart | |
| | | | | SmartcardProfileSpecificPart | |
| requestID | A | O | 0 . . . 1 | Identifier for the | unsignedInt |
| | | | | corresponding Service request | |
| | | | | message. | |
| global | A | O | 0 . . . 1 | The overall outcome of the | Unsigned- |
| Status | | | | request, according to the | Byte |
| Code | | | | return codes defined in section | |
| | | | | 5.11. | |
| | | | | If this attribute is present | |
| | | | | and set to value “0”, the | |
| | | | | request was completed | |
| | | | | successfully. In this case | |
| | | | | the ‘itemwiseStatusCode’ | |
| | | | | SHALL NOT be given per | |
| | | | | each requested | |
| | | | | ‘PurchaseItem’. | |
| | | | | If this attribute is present | |
| | | | | and set to some other | |
| | | | | value than “0”, there was a | |
| | | | | generic error concerning | |
| | | | | the entire request. In this | |
| | | | | case the | |
| | | | | ‘itemwiseStatusCode’ | |
| | | | | SHALL NOT be given per | |
| | | | | each requested | |
| | | | | ‘PurchaseItem’. | |
| | | | | If this attribute is not | |
| | | | | present, there was an error | |
| | | | | concerning one or more | |
| | | | | ‘PurchaseItem’ elements | |
| | | | | associated with the | |
| | | | | request. Further, the | |
| | | | | ‘itemwiseStatusCode’ | |
| | | | | SHALL be given per each | |
| | | | | requested ‘PurchaseItem’. | |
| adaptationMode | A | O | 0 . . . 1 | Informs the terminal of the | boolean |
| | | | | operational adaptation mode: | |
| | | | | Generic or BDS-specific | |
| | | | | adaptation | |
| | | | | false- indicates Generic | |
| | | | | adaptation mode | |
| | | | | true - indicates BDS-specific | |
| | | | | adaptation mode | |
| | | | | Note: this attribute SHALL be | |
| | | | | present only if the | |
| | | | | ‘globalStatusCode’ indicates | |
| | | | | “Success”, and the underlying | |
| | | | | BDS is BCMCS. | |
| PurchaseItem | E1 | O | 0 . . . N | Describes the results of the | |
| | | | | request message of | |
| | | | | subscribing to or purchasing | |
| | | | | the PurchaseItem. For the | |
| | | | | DRM Profile, if subscription | |
| | | | | or purchase is successful, | |
| | | | | rightsValidityEndTime of | |
| | | | | PurchaseItem will be present. | |
| | | | | For either the DRM Profile or | |
| | | | | Smartcard Profile, in the case | |
| | | | | of subscription/purchase | |
| | | | | failure, itemWiseStatusCode | |
| | | | | will be present to indicate the | |
| | | | | reason why the request is not | |
| | | | | accepted by BSM. | |
| | | | | Contains the following | |
| | | | | attributes: | |
| | | | | globalDRef | |
| | | | | itemwiseStatusCode | |
| globalIDRef | A | M | 1 | The ID of the Purchase Item. | anyURI |
| | | | | A purchase item is identified | |
| | | | | by the GlobalPurchaseItemID | |
| | | | | found in the PurchaseItem | |
| | | | | fragment. | |
| itemwiseStatus | A | O | 0 . . . 1 | Specifies a status code of each | Unsigned- |
| Code | | | | PurchaseItems using | Byte |
| | | | | GlobalStatusCode defined in | |
| | | | | the section 5.11. | |
| Subscription | E2 | O | 0 . . . 1 | The time interval during which | |
| Window | | | | the subscription is valid. | |
| | | | | The network SHOULD | |
| | | | | include this element for time- | |
| | | | | based subscriptions and MAY | |
| | | | | include it for pay-per-view. | |
| | | | | The terminal MAY use this | |
| | | | | information to determine the | |
| | | | | validity period of a | |
| | | | | subscription. | |
| | | | | Contains the following | |
| | | | | attributes: | |
| | | | | startTime | |
| | | | | endTime | |
| startTime | A | M | 1 | NTP timestamp expressing the | Unsigned- |
| | | | | start of subscription. | Int |
| endTime | A | O | 0 . . . 1 | NTP timestamp expressing the | Unsigned- |
| | | | | end of subscription. This | Int |
| | | | | attribute SHALL NOT be | |
| | | | | present for open-ended | |
| | | | | subscriptions. | |
| DrmProfile | E1 | O | 0 . . . 1 | Service & Content Protection | |
| SpecificPart | | | | DRM-profile specific part. | |
| | | | | This part is MANDATORY to | |
| | | | | support for DRM Profile, and | |
| | | | | is not applicable to the | |
| | | | | Smartcard Profile. | |
| | | | | Contains the following | |
| | | | | attributes: | |
| | | | | rightsValidityEndTime | |
| | | | | Contains the following | |
| | | | | elements: | |
| | | | | roap Trigger | |
| rights | A | O | 0 . . . 1 | The last time and date of | Unsigned- |
| Validity | | | | validity of the Long-Term Key | Int |
| EndTime | | | | Message, after which it has to | |
| | | | | be renewed. This attribute | |
| | | | | will be present when BSM | |
| | | | | accept the request message. | |
| | | | | This field is expressed as the | |
| | | | | first 32bits integer part of NTP | |
| | | | | time stamps. | |
| | | | | Note: this element is validated | |
| | | | | if RO is broadcasted. | |
| | | | | Otherwise, this element is not | |
| | | | | necessary. | |
| roap Trigger | E2 | O | 0 . . . 1 | ROAP RO Acquisition | reference to |
| | | | | Trigger**. The device is | “roap- |
| | | | | expected to use the trigger to | Trigger” |
| | | | | initiate one or more Long- | element as |
| | | | | Term Key Message | defined in |
| | | | | acquisitions. | OMA DRM |
| | | | | | 2.0 XML |
| | | | | | namespace |
| SmartcardProfile | E1 | O | 0 . . . 1 | Service & Content Protection | |
| SpecificPart | | | | Smartcard Profile specific | |
| | | | | part. This part is | |
| | | | | MANDATORY to support for | |
| | | | | the Smartcard Profile, and is | |
| | | | | not applicable to the DRM | |
| | | | | Profile. | |
| | | | | Contains the following | |
| | | | | attributes: | |
| | | | | RequestRegistration | |
| | | | | LTKM | |
| Request- | A | O | 0 . . . 1 | Indicates whether terminal go | Boolean |
| Registration | | | | through registration phase. If | |
| | | | | the value is ‘true’, terminal | |
| | | | | SHALL proceed registration | |
| | | | | specified in section 5.1.6.7. If | |
| | | | | the value is ‘false’, registration | |
| | | | | is not necessary. | |
| | | | | Note that this field SHALL be | |
| | | | | present only for successful | |
| | | | | service request. | |
| LTKM | E2 | O | 0 . . . N | Smartcard profile BCAST | base64- |
| | | | | LTKM (base64-encoded | Binary |
| | | | | MIKEY message). This | |
| | | | | element is present if the | |
| | | | | terminal and the BSM have | |
| | | | | agreed on “HTTP” as a LTKM | |
| | | | | delivery mechanism during the | |
| | | | | registration procedure (see | |
| | | | | section 5.1.6.10) | |
| UserDefined- | E1 | O | 0 . . . 1 | List of content and services | |
| Bundle | | | | requested to be bundled by the | |
| | | | | user | |
| | | | | Contains the following | |
| | | | | elements: | |
| | | | | UDBService | |
| | | | | UDBContent | |
| | | | | Note: Either or both the | |
| | | | | PurchaseItem or | |
| | | | | UserDefinedBundle element | |
| | | | | must be present in this | |
| | | | | message. | |
| UDBService | E2 | O | 0 . . . N | Service to be added to User | anyURI |
| | | | | Defined Bundle | |
| UDBContent | E2 | O | 0 . . . N | Content to be added to User | anyURI |
| | | | | Defined Bundle | |
| PurchaseItem | E2 | O | 0 . . . N | Purchase Item to be added to | anyURI |
| | | | | User Defined Bundle | |

Among the message elements of Table 5, a UserDefinedBundle element is used to indicate that the message is a response to the subscription request for the user defined bundle. An “UDBService” element denotes an identifier of a service that the user selected from the service guide and added to the user defined bundle. An “UDBcontent” element denotes an identifier of a content that the user selected from the service guide and added to the user defined bundle. “PurchaseItemID” denotes an identifier of the bundle provided by the service provider, which is added to the user defined bundle. Subscription success or failure may be set in this message. Accordingly, globalStatusCode may be set as defined in the BCAST. In step 311, a Long-Term Key Message (LTKM) is acquired in the terminal 301. However, an encryption message, required to access the contents or services, and the acquisition of the LTKM follows the definition given in the BCAST.

In an exemplary implementation, the user defined bundle response message with the format illustrated in Table 6 may also be used together with the user defined bundle response message illustrated in Table 5. According to the format illustrated in Table 6, some elements in the existing subscription request message defined in the BCAST may be added. The user defined bundle response message of Table 6 is used when the BSM 303 bundles up received services, contents or purchase items in a single purchase item and deals with the resulting purchase item as a user defined bundle.

TABLE 6

| Name | Type | Category | Cardinality | Description | Data Type |
|---|---|---|---|---|---|
| Service- | E | | | Service Response | |
| Response | | | | Message | |
| | | | | Contains the following | |
| | | | | attributes: | |
| | | | | requestID | |
| | | | | globalStatusCode | |
| | | | | adaptationMode | |
| | | | | Contains the following | |
| | | | | elements: | |
| | | | | PurchaseItem | |
| | | | | DrmProfileSpecificPart | |
| | | | | SmartcardProfileSpecific | |
| | | | | Part | |
| | | | | UserDefinedBundle | |
| requestID | A | O | 0 . . . 1 | Identifier for the | unsignedInt |
| | | | | corresponding Service | |
| | | | | request message. | |
| global | A | O | 0 . . . 1 | The overall outcome of | unsignedByte |
| Status | | | | the request, according to | |
| Code | | | | the return codes defined | |
| | | | | in section 5.11. | |
| | | | | If this attribute is | |
| | | | | present and set to | |
| | | | | value “0”, the request | |
| | | | | was completed | |
| | | | | successfully. In this | |
| | | | | case the | |
| | | | | ‘itemwiseStatusCode’ | |
| | | | | SHALL NOT be | |
| | | | | given per each | |
| | | | | requested | |
| | | | | ‘PurchaseItem’. | |
| | | | | If this attribute is | |
| | | | | present and set to | |
| | | | | some other value than | |
| | | | | “0”, there was a | |
| | | | | generic error | |
| | | | | concerning the entire | |
| | | | | request. In this | |
| | | | | ca $$ $$ $$ se the | |
| | | | | ‘itemwiseStatusCode’ | |
| | | | | SHALL NOT be | |
| | | | | given per each | |
| | | | | requested | |
| | | | | ‘PurchaseItem’. | |
| | | | | If this attribute is | |
| | | | | not present, there was | |
| | | | | an error concerning | |
| | | | | one or more | |
| | | | | ‘PurchaseItem’ | |
| | | | | elements associated | |
| | | | | with the request. | |
| | | | | Further, the | |
| | | | | ‘itemwiseStatusCode’ | |
| | | | | SHALL be given per | |
| | | | | each requested | |
| | | | | ‘PurchaseItem’. | |
| Adaptation- | A | O | 0 . . . 1 | Informs the terminal of | boolean |
| Mode | | | | the operational adaptation | |
| | | | | mode: Generic or BDS- | |
| | | | | specific adaptation | |
| | | | | false- indicates Generic | |
| | | | | adaptation mode | |
| | | | | true - indicates BDS- | |
| | | | | specific adaptation mode | |
| | | | | Note: this attribute | |
| | | | | SHALL be present only if | |
| | | | | the ‘globalStatusCode’ | |
| | | | | indicates “Success”, and | |
| | | | | the underlying BDS is | |
| | | | | BCMCS. | |
| PurchaseItem | E1 | O | 0 . . . N | Describes the results of | |
| | | | | the request message of | |
| | | | | subscribing to or | |
| | | | | purchasing the | |
| | | | | PurchaseItem. For the | |
| | | | | DRM Profile, if | |
| | | | | subscription or purchase | |
| | | | | is successful, | |
| | | | | rightsValidityEndTime of | |
| | | | | PurchaseItem will be | |
| | | | | present. For either the | |
| | | | | DRM Profile or | |
| | | | | Smartcard Profile, in the | |
| | | | | case of | |
| | | | | subscription/purchase | |
| | | | | failure, | |
| | | | | itemWiseStatusCode will | |
| | | | | be present to indicate the | |
| | | | | reason why the request is | |
| | | | | not accepted by BSM. | |
| | | | | Contains the following | |
| | | | | attributes: | |
| | | | | globalDRef | |
| | | | | itemwiseStatusCode | |
| globalIDRef | A | M | 1 | The ID of the Purchase | anyURI |
| | | | | Item. A purchase item is | |
| | | | | identified by the | |
| | | | | GlobalPurchaseItemID | |
| | | | | found in the | |
| | | | | PurchaseItem fragment. | |
| itemwiseStatusCode | A | O | 0 . . . 1 | Specifies a status code of | unsignedByte |
| | | | | each PurchaseItems using | |
| | | | | GlobalStatusCode | |
| | | | | defined in the section | |
| | | | | 5.11. | |
| Subscription- | E2 | O | 0 . . . 1 | The time interval during | |
| Window | | | | which the subscription is | |
| | | | | valid. | |
| | | | | The network SHOULD | |
| | | | | include this element for | |
| | | | | time-based subscriptions | |
| | | | | and MAY include it for | |
| | | | | pay-per-view. | |
| | | | | The terminal MAY use | |
| | | | | this information to | |
| | | | | determine the validity | |
| | | | | period of a subscription. | |
| | | | | Contains the following | |
| | | | | attributes: | |
| | | | | startTime | |
| | | | | endTime | |
| startTime | A | M | 1 | NTP timestamp | unsignedInt |
| | | | | expressing the start of | |
| | | | | subscription. | |
| endTime | A | O | 0 . . . 1 | NTP timestamp | unsignedInt |
| | | | | expressing the end of | |
| | | | | subscription. This | |
| | | | | attribute SHALL NOT be | |
| | | | | present for open-ended | |
| | | | | subscriptions. | |
| DrmProfile- | E1 | O | 0 . . . 1 | Service & Content | |
| SpecificPart | | | | Protection DRM-profile | |
| | | | | specific part. This part is | |
| | | | | MANDATORY to | |
| | | | | support for DRM Profile, | |
| | | | | and is not applicable to | |
| | | | | the Smartcard Profile. | |
| | | | | Contains the following | |
| | | | | attributes: | |
| | | | | rightsValidityEndTime | |
| | | | | Contains the following | |
| | | | | elements: | |
| | | | | roap Trigger | |
| rights | A | O | 0 . . . 1 | The last time and date of | unsignedInt |
| Validity | | | | validity of the Long-Term | |
| EndTime | | | | Key Message, after which | |
| | | | | it has to be renewed. | |
| | | | | This attribute will be | |
| | | | | present when BSM accept | |
| | | | | the request message. This | |
| | | | | field is expressed as the | |
| | | | | first 32bits integer part of | |
| | | | | NTP time stamps. | |
| | | | | Note: this element is | |
| | | | | validated if RO is | |
| | | | | broadcasted. Otherwise, | |
| | | | | this element is not | |
| | | | | necessary. | |
| roap Trigger | E2 | O | 0 . . . 1 | ROAP RO Acquisition | reference to |
| | | | | Trigger**. The device is | “roapTrigger” |
| | | | | expected to use the | element as |
| | | | | trigger to initiate one or | defined in |
| | | | | more Long-Term Key | OMA DRM |
| | | | | Message acquisitions. | 2.0 XML |
| | | | | | namespace |
| Smartcard- | E1 | O | 0 . . . 1 | Service & Content | |
| ProfileSpecificPart | | | | Protection Smartcard | |
| | | | | Profile specific part. This | |
| | | | | part is MANDATORY to | |
| | | | | support for the Smartcard | |
| | | | | Profile, and is not | |
| | | | | applicable to the DRM | |
| | | | | Profile. | |
| | | | | Contains the following | |
| | | | | attributes: | |
| | | | | RequestRegistration | |
| | | | | LTKM | |
| Request- | A | O | 0 . . . 1 | Indicates whether | Boolean |
| Registration | | | | terminal go through | |
| | | | | registration phase. If the | |
| | | | | value is ‘true’, terminal | |
| | | | | SHALL proceed | |
| | | | | registration specified in | |
| | | | | section 5.1.6.7. If the | |
| | | | | value is ‘false’, | |
| | | | | registration is not | |
| | | | | necessary. | |
| | | | | Note that this field | |
| | | | | SHALL be present only | |
| | | | | for successful service | |
| | | | | request. | |
| LTKM | E2 | O | 0 . . . N | Smartcard profile | base64Binary |
| | | | | BCAST LTKM (base64- | |
| | | | | encoded MIKEY | |
| | | | | message). This element is | |
| | | | | present if the terminal | |
| | | | | and the BSM have agreed | |
| | | | | on “HTTP” as a LTKM | |
| | | | | delivery mechanism | |
| | | | | during the registration | |
| | | | | procedure (see section | |
| | | | | 5.1.6.10) | |
| UserDefined- | E1 | O | 0 . . . 1 | List of content and | |
| Bundle | | | | services requested to be | |
| | | | | bundled by the user | |
| | | | | Contains the following | |
| | | | | elements: | |
| | | | | PurchaseItemFragment | |
| | | | | PurchaseDataFragment | |
| PurchaseItem- | E2 | O | 0 . . . N | Purchase Item Service | Complex Type |
| Fragment | | | | guide fragments | |
| | | | | containing information | |
| | | | | for the User Defined | |
| | | | | Bundle. The fragment | |
| | | | | format is specified in | |
| | | | | [BCAST10-SG] | |
| PurchaseData- | E2 | O | 0 . . . N | Purchase Data Service | Complex Type |
| Fragment | | | | guide fragments | |
| | | | | containing information | |
| | | | | for the User Defined | |
| | | | | Bundle. The fragment | |
| | | | | format is specified in | |
| | | | | [BCAST10-SG] | |

Among the message elements written in Table 6, a UserDefinedBundle element is used to indicate that the message is a response to the subscription request for the user defined bundle. In addition, PurchaseItemFragment and PurchaseDataFragment are used when the BSM 303 newly defines purchase items at the server for the user and provides a user defined bundle service.

The PurchaseItemFragment provides a bundle of services, contents, times and the like for a user defined bundle. The PurchaseDataFragment contains detailed purchase and subscription information, including price information and promotion information for the bundle of the PurchaseItemFragment. One of Table 5 and Table 6 illustrating the defined response message may be selectively used according to implementation of the BCAST system. It is to be noted that the user defined bundle response message is not limited to Table 5 or Table 6, and various changes may be made. When using Table 6, the terminal 301 and the BSM 303 may perform in step 311 the common BCAST service subscription procedure using PurchaseItemFragment and PurchaseDataFragment that was exchanged based on Table 6. The common BCAST service subscription procedure is not described herein for simplicity.

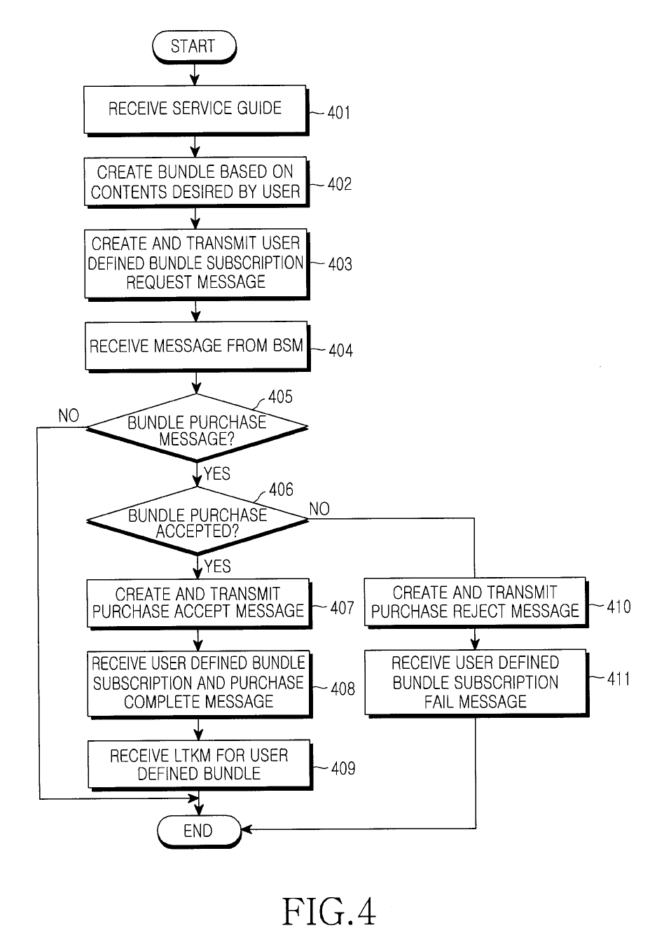

FIG. 4 illustrates an operation of a terminal according to an exemplary embodiment of the present invention.

Referring to FIG. 4, a terminal 301 receives a service guide from a BSDA 302 in step 401. The terminal 301 illustrates the received service guide to a user. When the user selects its desired contents or services and notifies the results to the terminal 301, the terminal 301 bundles up the selected contents or services in a user defined bundle in step 402, and creates a user defined bundle subscription request message and transmits the user defined bundle subscription request message to the BSM 303 in step 403. The message created in step 403 is similar to the message of Table 2 described in connection with FIG. 3.

After transmitting the user defined bundle subscription request message in step 403, the terminal 301 receives a response message from a server in step 404 and determines the type of message in step 405. That is, the terminal 301 determines whether the message type is a bundle purchase message (or a purchase inquiry request message) or a purchase reject message (or a user defined bundle response message). If the message received in step 404 is not a purchase inquiry request message and is a user defined bundle response message (illustrated in Table 5 or Table 6), the terminal 301 ends the user defined bundle purchase process because the BSM 303 did not allow the subscription. In this case, globalStatusCode written in the message of Table 5 or Table 6 indicates subscription failure.

However, if the message is the purchase inquiry request message (Table 3) in step 405, the terminal 301 requests the user to verify the price written in the purchase inquiry request message and determines in step 406 whether the user has accepted the purchase inquiry request.

If the user rejects the request, the terminal 301 creates a purchase inquiry response message with a rejection set, and transmits the purchase inquiry response message to the BSM 303 in step 410. In step 411, the terminal 301 receives a user defined bundle response message with a subscription failure from the BSM 303. In this case, globalStatusCode in the message indicates the subscription failure. On the other hand, when the user determines whether to purchase the service at the price presented by the BSM 303, i.e., when the user accepts the purchase inquiry request message, the terminal 301 creates a purchase inquiry response message (illustrated in Table 4) with the acceptance and transmits the purchase inquiry response message to the BSM 303 in step 407. After transmitting the purchase inquiry response message to the BSM 303 in step 407, the terminal 301 receives a user defined bundle response message (illustrated in Table 5 or Table 6) from the BSM 303 in step 408. If the message is received in step 408, unlike the message received in step 405 or in step 411, the subscription success is marked in the globalStatusCode element. In step 409, the terminal 301 receives an LTKM defined in the BCAST, required to access the contents or services.

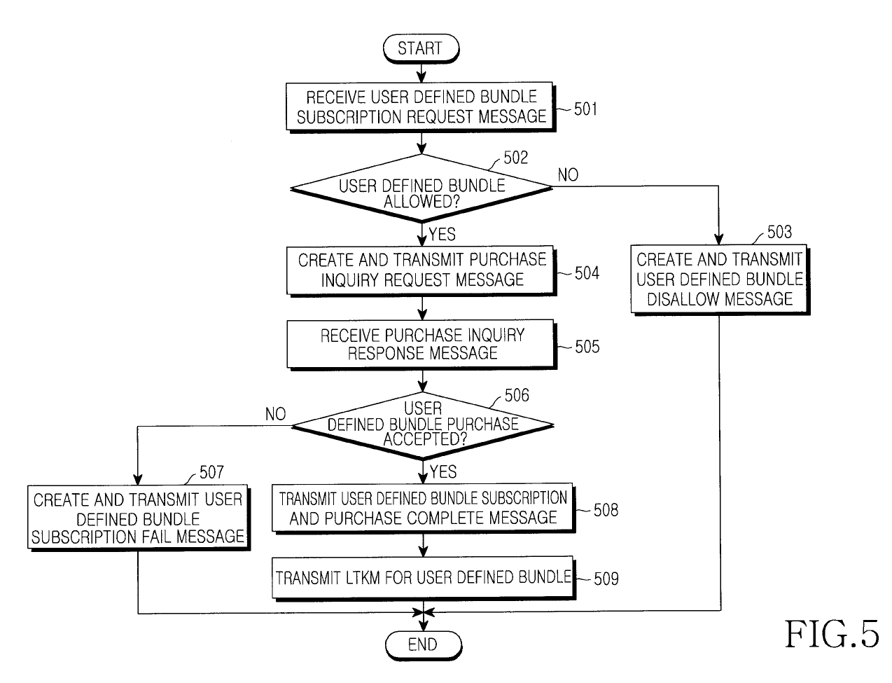

FIG. 5 illustrates an operation of a BSM according to an exemplary embodiment of the present invention.

Referring to FIG. 5, a BSM 303 receives a user defined bundle subscription request message from a terminal 301 in step 501. A format of the message received in step 501 is similar to the format of the user defined bundle subscription request message in Table 2. After examining the message, the BSM 303 determines whether to provide a user defined bundle service in step 502. When the BSM 303 determines that it cannot offer the service, the BSM 303 marks a user defined bundle response message with subscription disallowance and transmits the user defined bundle response message to the terminal 301 in step 503. The user defined bundle response message being transmitted is similar to the user defined bundle response message in Table 5 or Table 6. The globalStatusCode element in the message is set as a subscription failure.

However, when the BSM 303 allows the user defined bundle subscription request in step 502, the BSM 303 determines the price for the user defined bundle, creates a purchase inquiry request message as illustrated in Table 2, and transmits the purchase inquiry request message to the terminal 301 in step 504. In step 505, the BSM 303 receives a response to the purchase inquiry request message transmitted in step 504, i.e., receives a purchase inquiry response message. After analyzing the message, the BSM 303 determines whether the user has rejected the purchase. If the user rejected the purchase, the BSM 303 sets the globalStatusCode element in the user defined bundle response message (illustrated in Table 5 and Table 6) as subscription failure, and transmits the user defined bundle response message to the terminal 301 in step 507. However, when the user has accepted the subscription in step 506, the BSM 303 sets the globalStatusCode element in the user defined bundle response message (illustrated in Table 5 or Table 6) as subscription success, and transmits the user defined bundle response message to the terminal 301 in step 508. In step 509, the BSM 303 transmits an LTKM used to access the contents or services, to the terminal 301 in accordance with the method defined in the BCAST.

As is apparent from the foregoing description, exemplary embodiments of the present invention provides a user defined bundle composed of services selected by taking a user preference into account, thereby offering user-centered services.

Exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, function programs, codes, and code segments for accomplishing the present invention can be easily construed as within the scope of the invention by programmers skilled in the art to which the present invention pertains.

While the invention has been shown and described with reference to a certain exemplary embodiments thereof, it will be understood by those skilled in the art that various changes in form and details may be made therein without departing from the spirit and scope of the invention as defined by the appended claims and their equivalents.

What is claimed is:

1. A method for providing a user defined bundle in a terminal of a mobile broadcast system, the method comprising:
receiving a service guide from a BroadCAST (BCAST) Service Distribution/Adaptation (BSDA);
creating a user defined bundle based on one of a content and a service;
including the user defined bundle in a user defined bundle subscription request message and transmitting the user defined bundle subscription request message to a BCAST Subscription Management (BSM); and
receiving from the BSM a user defined bundle subscription response message in which a user defined bundle subscription and a purchase complete message is included.

2. The method of claim 1, further comprising determining whether the message received from the BSM is a user defined bundle subscription response message.

3. The method of claim 1, wherein the service guide comprises information for creating the user defined bundle.

4. The method of claim 1, further comprising, upon receipt of a purchase reject from the user, creating a purchase inquiry response message with a purchase reject message and transmitting the purchase inquiry response message to the BSM.

5. The method of claim 4, further comprising receiving from the BSM a user defined bundle subscription response message in which a user defined bundle subscription full message is included.

6. The method of claim 1, further comprising receiving a Long-Term Key Message (LTKM) required for one of content and service subscription.

7. A method for providing a user defined bundle in a BroadCAST (BCAST) Subscription Management (BSM) of a mobile broadcast system, the method comprising:
receiving a user defined bundle subscription request message from a terminal;
determining whether to provide a user defined bundle service;
receiving a purchase inquiry response message from the terminal and verifying whether a user accepts a purchase by analyzing the purchase inquiry response message;
including a user defined bundle subscription and purchase complete message in a user defined bundle subscription response message; and
transmitting the user defined bundle subscription response message to the terminal when the user accepts the purchase.

8. The method of claim 7, further comprising transmitting a purchase inquiry request message with price information for the user defined bundle service to the terminal.

9. The method of claim 7, further comprising transmitting to the terminal a purchase inquiry response message with a purchase reject message when the user rejects the purchase.

10. The method of claim 7, further comprising transmitting to the terminal a Long-Term Key Message (LTKM) required for one of content subscription and service subscription.

11. A mobile communication system providing a user defined bundle, the system comprising:
a terminal for receiving a service guide from a BroadCAST (BCAST) Service Distribution/Adaptation (BSDA), for creating a user defined bundle based on one of a content and a service desired by a user, for including the user defined bundle in a user defined bundle subscription request message, for transmitting the user defined bundle subscription request message to a BCAST Subscription Management (BSM), for receiving a purchase inquiry request message from the BSM, for creating a purchase inquiry response message upon receipt of a purchase accept from the user, for transmitting the purchase inquiry response message to the BSM, and for receiving a user defined bundle subscription response message with a user defined bundle subscription and purchase complete message from the BSM; and
the BSM for receiving the user defined bundle subscription request message from the terminal, for determining whether to provide a user defined bundle service by analyzing the user defined bundle subscription request message, for including the user defined bundle service in the purchase inquiry request message when the BSM determines to provide the user defined bundle, for transmitting the purchase inquiry request message to the terminal, for receiving the purchase inquiry response message from the terminal, for determining whether the user accepts the purchase by analyzing the purchase inquiry response message, for including the user defined bundle subscription and purchase complete message in the user defined bundle subscription response message when it is determined that the user accepts the purchase, and for transmitting the user defined bundle subscription response message to the terminal.

12. The system of claim 11, wherein the terminal receives the purchase inquiry request message, creates a purchase inquiry response message with a purchase reject message upon receipt of a purchase reject from the user, and transmits the purchase inquiry response message to the BSM.

13. The system of claim 12, wherein the terminal receives from the BSM a user defined bundle subscription response message in which a user defined bundle subscription full message is included.

14. The system of claim 11, wherein the terminal receives a Long-Term Key Message (LTKM) required for one of content subscription and service subscription after receiving the user defined bundle subscription response message in which the user defined bundle subscription and purchase complete message is included.

15. The system of claim 11, wherein the BSM includes a purchase reject message in a purchase inquiry response message and transmits the purchase inquiry response message to the terminal when the user rejects the purchase.

16. The system of claim 11, wherein the purchase inquiry request message includes price information for the user defined bundle service.

17. The system of claim 11, wherein the BSM transmits to the terminal an LTKM required for one of content subscription and service subscription after including the user defined bundle subscription and purchase complete message in the user defined bundle subscription response message.

18. The system of claim 17, wherein the BSM transmits the user defined bundle subscription response message to the terminal.
